(19) United States
(12) Patent Application Publication
(10) Pub. No.: US 2025/0083111 A1
(43) Pub. Date: Mar. 13, 2025

(54) LINEAR MULTIFUNCTIONAL ALIPHATIC AND HYPER-CROSS-LINKED POLYAMIDE MEMBRANE

(71) Applicant: KING FAHD UNIVERSITY OF PETROLEUM AND MINERALS, Dhahran (SA)

(72) Inventors: Umair BAIG, Dhahran (SA); Abdul WAHEED, Dhahran (SA)

(73) Assignee: KING FAHD UNIVERSITY OF PETROLEUM AND MINERALS, Dhahran (SA)

(21) Appl. No.: 18/466,395

(22) Filed: Sep. 13, 2023

(51) Int. Cl. B01D 69/12; B01D 61/02; B01D 69/02; B01D 69/10; B01D 71/44; B01D 71/56; B01D 71/68

(52) U.S. Cl. CPC B01D 69/1251; B01D 61/027; B01D 69/02; B01D 69/107; B01D 71/441; B01D 71/56; B01D 71/68; B01D 2325/04; B01D 2325/06

(57) ABSTRACT

A filtration membrane includes a thermoplastic substrate, a first layer comprising a polysulfone, a polyvinylpyrrolidone, and a tetramine, and a second layer comprising the tetramine and reacted units of a phthaloyl chloride cross-linked to form a polyamide. A method of preparing the filtration membrane by impregnating tetramine in an ultrafiltration support matrix for rapidly fabricating a hyper-cross-linked polyamide membrane. The membrane prepared by the method of present disclosure can be used for nanofiltration.

### STATEMENT REGARDING PRIOR DISCLOSURE BY THE INVENTORS

Aspects of the present disclosure were disclosed in an article titled “Exploiting interfacial polymerization to fabricate hyper-cross-linked nanofiltration membrane with a constituent linear aliphatic amine for freshwater production” by Baig, U. and Waheed, A., published in Volume 5, npj Clean Water, which is incorporated herein by reference in its entirety.

### STATEMENT OF ACKNOWLEDGEMENT

The support provided by the Interdisciplinary Research Center for Membranes and Water Security, King Fahd University of Petroleum and Minerals, Saudi Arabia, through project INMW2111 is gratefully acknowledged.

### BACKGROUND

### Technical Field

The present disclosure relates to membrane fabrication, particularly to a linear multifunctional aliphatic amine as an integral constituent for the rapid fabrication of a hyper-cross-linked polyamide membrane.

### Discussion of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Humanity faces the challenge of water scarcity due to a rapidly growing population and industrialization. In addition to conventional sources of water from glacier melt and rainfall, more sources of water are needed to meet the demands of the growing population across the globe. Today 40% of the world's population is already facing a severe water crisis. Desalination of seawater or brackish water has played a role in meeting the demands of water consumption by the worldwide population. Currently, there are about 16,000 operational desalination plants distributed across 177 countries, and these plants are producing 95 million m³/day of desalinated water. Almost half of the global desalination capacity (48%) is in the Middle East and North Africa. The development of membrane-based desalination is gradually replacing thermal-based desalination. In 2000, membrane-based desalination was producing 50% of the desalinated water. Nowadays, membrane desalination is about 65.5 million m³/day of the total 95 million m³/day of desalinated water.

Membrane-based desalination is thus a leading technology to desalinate widely available seawater. The success and significance of membrane desalination are evident because this technology has been practiced for 30 years.

Polyamide membranes have been extensively studied and applied commercially for multivariate applications such as nanofiltration, wastewater treatment, organic solvent nanofiltration, chiral separations, and reverse osmosis. Membranes are designed to have a fine pore structure with a selective polyamide layer. A uniformly distributed fine pore structure of the membrane enables the separation of Angstrom-sized molecules. Progress has been made by researchers in improving the capability of polyamide membranes regarding nanofiltration (NF) and reverse osmosis (RO).

Thin film composite nanofiltration (TFC-NF) membranes are widely used in industrial and commercial setups. Generally, NF membranes possess an architecture having a thin film composite structure with a polyamide active layer. The fabrication of the membrane is carried out through interfacial polymerization (IP), where an aqueous solution of an amine is reacted with an acid chloride contained in a non-aqueous (n-hexane) phase. The amines which are most commonly employed in IP are diamines, such as piperazine (PIP), m-phenylenediamine (MPD), and ethylene diamine (EDA), which are cross-linked by reacting with trimesoyl chloride (TMC). The diamine and TMC react through the Schotten-Baumann reaction leading to a hyper-cross-linked polyamide active layer. Although much progress has been made, a majority of the work has been limited to diamines that offer just two reaction sites for cross-linking and determine the degree of cross-linking. The availability of a multitude of amines with three or four active amine functions along with readily hexane-soluble cross-linkers, such as terephthaloyl chloride (TPC), may allow further tunability of the pore structure and thickness of the polyamide active layer leading to fabrication of thin, selective, and highly cross-linked polyamide network.

Various amines, including MPD, EDA, PIP, diethylene triamine (DETA), melamine, and tetra-ethylene pentaamine (TEPA), have been cross-linked by using cyanuric chloride (CC) as a cross-linker. Out of the fabricated membranes, the DETA/CC membrane was the best membrane in terms of flux (15.0 LMH) and salt rejection (85.2% of NaCl) [Lee, K. P., Bargeman, G., de Rooij, R., Kemperman, A. J. B. & Benes, N. E. Interfacial polymerization of cyanuric chloride and monomeric amines: pH resistant thin film composite polyamine nanofiltration membranes. J Memb. Sci. 523, 487-496 (2017), incorporated herein by reference in its entirety]. Similarly, a relatively less explored and readily hexane-soluble cross-linker terephthaloyl chloride (TPC) has been employed to fabricate a novel nanofiltration membrane for organic solvent nanofiltration (OSN), and the fabricated membrane was able to reject the tested dyes, such as Nile red and rhodamine, while the structure of the membrane remained intact in different organic solvents such as methanol and ethanol [Huang, T. et al. Molecularly-porous ultrathin membranes for highly selective organic solvent nanofiltration. Nat. Commun. 2020 111 11, 1-10 (2020), incorporated herein by reference in its entirety]. A polyamide TFC-NF membrane was synthesized by using polyethyleneimine (PEI) and TMC with a molecular weight cut-off (MWCO) of ≈180 Da with a permeate flux of 14-24 L m⁻² h⁻¹ bar⁻¹ [Trivedi, J. S., Bhalani, D. V., Bhadu, G. R. & Jewrajka, S. K. Multifunctional amines enable the formation of polyamide nanofilm composite ultrafiltration and nanofiltration membranes with modulated charge and performance. J. Mater. Chem. A 6, 20242-20253 (2018), incorporated herein by reference in its entirety]. Similarly, multifunctional linear amines, such as diethylene triamine (DETA), have also been used in the fabrication of interlayers during membrane preparation. An interlayer prepared by constituting DETA and tannic acid lead to a TFC-NF membrane with >98% rejection of Na₂SO₄ [Zhang, X., Lv, Y., Yang, H. C., Du, Y. & Xu, Z. K. Polyphenol coating as an interlayer for thin-film composite membranes with enhanced nanofiltration performance. ACS Appl. Mater. Interfaces 8, 32512-32519 (2016), incorporated herein by reference in its entirety].

Although amines have been used for membrane fabrication in the past, there still exists a need to develop highly efficient membrane fabrication processes with simple chemistry in a cost-effective manner. Accordingly, an object of the present disclosure is to develop hyper-cross-linked and dense polyamide thin film composite nanofiltration membrane comprising a linear multifunctional aliphatic amine cross-linked with a crosslinker molecule, circumventing the drawbacks of the art.

### SUMMARY

In an exemplary embodiment of the present disclosure, a filtration membrane is disclosed. The filtration membrane includes a thermoplastic substrate, a first layer comprising a polysulfone, a polyvinylpyrrolidone, and a tetramine, and a second layer including the tetraamine and reacted units of a phthaloyl chloride cross-linked with the tetramine to form a polyamide.

In some embodiments, the tetramine in the first layer is physically adsorbed in the polysulfone and the polyvinylpyrrolidone.

In some embodiments, the tetramine in the second layer is covalently cross-linked with reacted units of the phthaloyl chloride through at least one of a primary amine group and a secondary amine group of a first tetramine and at least one of a primary amine group and a secondary amine group of a second tetramine.

In some embodiments, the second layer comprises the polyamide in a hyper-branched cross-linked matrix.

In some embodiments, the tetramine is an N,N′-bis(3-aminopropyl)ethylenediamine.

In some embodiments, the second layer is in the form of nanoparticles with a diameter of 10 to 500 nanometers (nm).

In some embodiments, the first layer is in the form of vertical hollow tubes having a diameter of 0.1 to 10 micrometers (μm) and a length of 1 to 50 μm.

In some embodiments, the second layer covers the vertical hollow tubes of the first layer.

In some embodiments, the second layer has a thickness of 0.1 to 10 μm.

In some embodiments, the membrane has a water contact angle is from 60 to 90°.

In some embodiments, the membrane has carbon in an amount of 78 to 81% by weight, oxygen in an amount of 10 to 13% by weight, sulfur in an amount of 5 to 7% by weight, and nitrogen in an amount of 2 to 4% by weight based on a total weight of the membrane.

In some embodiments, the membrane has a surface roughness is from 9 to 11 nm.

In some embodiments, the membrane has a rate of flux of 30 to 40 L m⁻² h⁻¹ at a pressure of 20 bar.

In an exemplary embodiment, a method of making the filtration membrane is described. The filtration membrane includes dissolving the polysulfone and the polyvinylpyrrolidone in a solvent to form a solution; fixing the thermoplastic substrate on a glass surface; spreading the solution on the thermoplastic substrate fixed on the glass surface to form a support; soaking the support in an organic anionic surfactant; dipping the support in an aqueous solution of the tetramine to adsorb the tetramine to the support and form the first layer; contacting the first layer with an organic solution of the phthaloyl chloride to form the polyamide; and heating to from the filtration membrane.

In some embodiments, the heating is from 50 to 120° C.

In some embodiments, the heating occurs for 20 to 120 minutes.

In an exemplary embodiment, a method of nanofiltration is described. The method includes passing a composition through the filtration membrane, wherein the composition comprises at least solvents and solutes, and collecting a permeate passing through the filtration membrane to obtain a purified composition having a reduced amount of solutes.

In some embodiments, the membrane has a rejection profile of solutes from 85 to 100% by weight.

In some embodiments, the method includes contacting the filtration membrane with an aqueous acidic solution before passing a composition through the filtration membrane.

In some embodiments, the method includes passing a composition through the filtration membrane occurs for 0.5 to 15 hours.

These and other aspects of non-limiting embodiments of the present disclosure will become apparent to those skilled in the art upon review of the following description of specific non-limiting embodiments of the disclosure in conjunction with the accompanying drawings.

### BRIEF DESCRIPTION OF THE DRAWINGS

A better understanding of embodiments of the present disclosure (including alternatives and/or variations thereof) may be obtained with reference to the detailed description of the embodiments along with the following drawings, in which:

FIG. 1 is a flowchart depicting a method of making a membrane, according to an aspect of the present disclosure;

FIG. 2 is a schematic illustration depicting various stages of fabrication of hyper-cross-linked polyamide thin film composite nanofiltration (HCPA-TFC-NF) membranes, according to an aspect of the present disclosure;

FIG. 3 shows the chemical structures of the reacting monomers and reagents for interfacial polymerization (IP), according to certain embodiments;

FIG. 4A is a pictorial image depicting a free-standing active layer as a white sheet at the interface between the two phases, according to an aspect of the present disclosure;

FIG. 4B shows a solid cross-polarization magic angle spin (CP-MAS) ¹³C nuclear magnetic resonance (NMR) of the active layer generated by reacting N,N′-bis(3-aminopropyl)ethylenediamine (1) and terephthaloyl chloride (TPC) (2), according to certain embodiments;

FIG. 5A is a schematic illustration depicting reaction conditions and the proposed structure of the hyper-cross-linked polyamide (HCPA) active layer, according to certain embodiments;

FIG. 5B shows Fourier Transform Infrared (FTIR) spectra of N,N′-bis(3-aminopropyl)ethylenediamine (1) and TPC (2) and polyamide active layer showing the region from 4000 cm⁻¹ to 400 cm⁻¹, according to certain embodiments;

FIG. 5C shows FTIR peaks of carbonyl groups and the fingerprint region corresponding to FIG. 4A, according to certain embodiments;

FIG. 6A and FIG. 6B shows FTIR of a polysulfone/polyethylene terephthalate (PS/PET) support, and various HCPA-TFC-NF membranes, namely, HCPA-TFC-NF@M1, HCPA-TFC-NF@M2, and HCPA-TFC-NF@M3, according to certain embodiments;

FIG. 7 shows attenuated total reflectance Fourier transform infrared (ATR-FTIR) of a polyethylene terephthalate (PET) nonwoven support, according to certain embodiments;

FIG. 8 shows a variation of water contact angle (WCA) of the PS/PET support, and various HCPA-TFC-NF membranes, according to certain embodiments;

FIGS. 9A-9C shows field emission scanning electron micrograph (FESEM) images of the PS/PET support, at different magnifications, according to certain embodiments;

FIGS. 9D-9F shows FESEM images of the HCPA-TFC-NF@M2 membrane, at different magnifications, according to certain embodiments;

FIGS. 9G-9I shows cross-sectional FESEM images HCPA-TFC-NF@M2, at different magnifications, according to certain embodiments;

FIGS. 10A and 10B show field emission scanning electron microscopy (FESEM) with energy dispersive spectroscopy (FESEM-EDS) analysis of the PS/PET support, according to certain embodiments;

FIGS. 10C and 10D show FESEM-EDS analysis of the HCPA-TFC-NF@M2 membrane, according to certain embodiments;

FIG. 11A shows energy dispersive X-ray spectra (EDS) layered image for the PS/PET support, according to certain embodiments;

FIG. 11B shows elemental mapping analysis of the PS/PET support for carbon (C), according to certain embodiments;

FIG. 11C shows elemental mapping analysis of the PS/PET support for sulphur (S), according to certain embodiments;

FIG. 11D shows elemental mapping analysis of the PS/PET support for oxygen (O), according to certain embodiments;

FIG. 11E shows EDX layered image for the HCPA-TFC-NF@M2 membrane, according to certain embodiments;

FIG. 11F shows elemental mapping analysis of the HCPA-TFC-NF@M2 membrane for carbon, according to certain embodiments;

FIG. 11G shows elemental mapping analysis of the HCPA-TFC-NF@M2 membrane for sulphur, according to certain embodiments;

FIG. 11H shows elemental mapping analysis of the HCPA-TFC-NF@M2 membrane for oxygen, according to certain embodiments;

FIG. 11I shows elemental mapping analysis of the HCPA-TFC-NF@M2 membrane for nitrogen (N), according to certain embodiments;

FIG. 12A shows a two-dimensional (2D) atomic force microscopy (AFM) image of the PS/PET support, according to certain embodiments;

FIG. 12B shows a three-dimensional (3D) AFM image of the PS/PET support, according to certain embodiments;

FIG. 12C shows a 2D AFM image of the HCPA-TFC-NF@M2 membrane, according to certain embodiments;

FIG. 12D shows a 3D AFM image of the HCPA-TFC-NF@M2 membrane, according to certain embodiments;

FIG. 12E shows X-ray photoelectron spectroscopy (XPS) survey scan of the PS/PET support and HCPA-TFC-NF@M2 membrane, according to certain embodiments;

FIG. 13A shows a deconvolution of C1s X-ray photoelectron spectroscopy (XPS) survey scan of the PS/PET support, according to certain embodiments;

FIG. 13B shows a deconvolution of O1s XPS survey scan of the PS/PET support, according to certain embodiments;

FIG. 13C shows a deconvolution of S2p XPS survey scan of the PS/PET support, according to certain embodiments;

FIG. 13D shows a deconvolution of CIs XPS survey scan of the HCPA-TFC-NF@M2 membrane, according to certain embodiments;

FIG. 13E shows a deconvolution of O1s XPS survey scan of the HCPA-TFC-NF@M2 membranes, according to certain embodiments;

FIG. 13F shows a deconvolution of S2p XPS survey scan of the HCPA-TFC-NF@M2 membranes, according to certain embodiments;

FIG. 13G shows a deconvolution of N1s XPS survey scan of the HCPA-TFC-NF@M2 membranes, according to certain embodiments;

FIG. 14 is a graph showing surface zeta potential of the HCPA-TFC-NF@M2 and HF-treated HCPA-TFC-NF@M2 membranes at various pH values, according to certain embodiments;

FIG. 15A is a graph showing effect of cross-linking temperature on water flux, with the HCPA-TFC-NF@M2 membrane, according to certain embodiments;

FIG. 15B is a graph showing the effect of cross-linking temperature on percentage salt rejection, at constant pressure (20 bar), with the HCPA-TFC-NF@M2 membrane, according to certain embodiments;

FIG. 15C is a graph showing the effect of cross-linking time on water flux, with the HCPA-TFC-NF@M2 membrane, according to certain embodiments;

FIG. 15D is a graph showing the effect of cross-linking time on percentage salt rejection, at constant pressure (20 bar), with the HCPA-TFC-NF@M2 membrane, according to certain embodiments;

FIG. 16A is a graph showing the effect of different pressure on the water flux of the membranes fabricated at different cross-linking temperatures using crossflow nanofiltration setup, according to certain embodiments;

FIG. 16B is a graph showing the salt rejection performance of the membranes, fabricated at different cross-linking temperatures of 60° C., 80° C., and 100° C., and for a cross-linking time of 60 minutes using a crossflow filtration setup at constant pressure (20 bar), according to certain embodiments;

FIG. 16C is a graph showing a long-term stability test for performance evaluation of the HCPA-TFC-NF@M2 membrane, by measuring normalized flux over a period, according to certain embodiments;

FIG. 16D is a graph showing a long-term stability test for performance evaluation of the HCPA-TFC-NF@M2 membrane, by measuring percentage salt rejection over a period, according to certain embodiments;

FIG. 17 is a graph showing permeability of different solutes through HCPA-TFC-NF@M2 at 20 bar pressure and a concentration of 2 g L⁻¹, according to certain embodiments;

FIG. 18A shows the proposed structure of the protonated membrane active layer, according to certain embodiments;

FIG. 18B shows performance of the HCPA-TFC-NF@M2 membrane before and after treatment with hydrofluoric acid (HF) in terms of pure water flux, according to certain embodiments;

FIG. 18C shows a performance of the HCPA-TFC-NF@M2 membrane in rejecting three divalent ions using crossflow filtration setup at constant pressure (20 bar) and temperature (23° C.), according to certain embodiments;

FIG. 18D shows water contact angle of the HCPA-TFC-NF@M2 (M2) and the HF-treated HCPA-TFC-NF@M2 (HF-treated M2) membranes, according to certain embodiments;

FIG. 18E shows FTIR spectra of the HCPA-TFC-NF@M2 (M2) and the HF-treated M2 membranes, according to certain embodiments;

FIG. 18F shows 2D-AFM image of the HCPA-TFC-NF@M2 membrane, according to certain embodiments;

FIG. 18G shows 3D-AFM image of the HCPA-TFC-NF@M2 membrane, according to certain embodiments;

FIG. 18H shows 2D-AFM image of the HF-treated M2 membrane, according to certain embodiments;

FIG. 18I shows 3D-AFM image of the HF-treated M2 membrane, according to certain embodiments;

FIGS. 18J and 18K show FESEM micrographs of the HCPA-TFC-NF@M2 membrane, at different magnifications, according to certain embodiments;

FIGS. 18L and 18M show FESEM micrographs of the HF-treated M2 membrane, at different magnifications, according to certain embodiments;

FIG. 19 is a graph showing effect of temperature on the water flux of the HCPA-TFC-NF@M2 membrane using a crossflow filtration setup at constant pressure (20 bar), according to certain embodiments;

FIG. 20A is a graph showing permeate flux of Eriochrome black T (EBT) feed by the HCPA-TFC-NF@M2 (M2) and the HF-treated M2 membranes, according to certain embodiments; and

FIG. 20B is a graph showing percentage rejection of EBT by the HCPA-TFC-NF@M2 (M2) and the HF-treated M2 membrane, according to certain embodiments.

### DETAILED DESCRIPTION

In the following description, it is understood that other embodiments may be utilized, and structural and operational changes may be made without departure from the scope of the present embodiments disclosed herein.

Reference will now be made in detail to specific embodiments or features, examples of which are illustrated in the accompanying drawings. Wherever possible, corresponding, or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Furthermore, the terms “approximately,” “approximate,” “about,” and similar terms generally refer to ranges that include the identified value within a margin of 20%, 10%, or preferably 5%, and any values therebetween.

As used herein, the singular terms “a”, “an”, and “the” include plural referents, unless otherwise specified. Likewise, the plural term “multilayer” as used herein includes a singular referent comprising a monolithic or monolayer structure, unless specified otherwise.

As used herein, the term “membrane” as used herein refers to a porous structure that is capable of separating components of a homogeneous or heterogeneous fluid. Unless specified otherwise, the term “porous” as used herein refers to microporous, mesoporous, microporous, and combinations thereof. As used herein, the term “micropore” refers to a pore with a size ≤2 nm, the term “mesopore” refers to a pore size between 2 and 50 nm, and the term “macropore” refers to a pore with a size ≥50 nm. In particular, “pores” in the sense of the present disclosure indicate voids allowing fluid communication between different sides of the structure. More particular in use when a homogeneous or heterogeneous fluid is passed through the membrane, some components of the fluid can pass through the pores of the membrane into a “permeate stream”, some components of the fluid can be retained by the membrane and can thus accumulate in a “retentate” and/or some components of the fluid can be rejected by the membrane into a “rejection stream”. Membranes can be of various thicknesses, with homogeneous or heterogeneous structures. Membranes can be in the form of flat sheets or bundles of hollow fibers. Membranes can also be in various configurations including, but not limited to, spiral wound, tubular, hollow fiber, and other configurations identifiable to a skilled person upon a reading of the present disclosure. Membranes can also be classified according to their pore diameter. Membranes can be neutral or charged. Particle transport can be active or passive, with the latter facilitated by pressure, concentration, chemical or electrical gradients of the membrane process, and the like.

As used herein, the term “surfactant” refers to a chemical compound that decreases the surface tension or interfacial tension between two liquids, a liquid and a gas, or a liquid and a solid. In an embodiment, the surfactant may refer to an organic chemical that, when added to a liquid, changes the properties of that liquid at a surface. In an embodiment, the surfactant may refer to an organic chemical that, when added to a surface, changes the properties of that surface. In an embodiment, the surfactant may function as an emulsifier, a wetting agent, a detergent, a foaming agent, a dispersant, a combination thereof, and the like. In some embodiments, the surfactant may be ionic, nonionic, amphiphilic, and the like. In an embodiment, a surfactant molecule may include one or more hydrophilic units attached to one or more hydrophobic units. The hydrophobic unit of the surfactant may include a hydrocarbon chain, which can be branched, linear, aromatic, or a combination thereof. In some embodiments, the one or more hydrophilic units may be a hydrophilic head. In some embodiments, the one or more hydrophobic units may be a hydrophobic tail. In some embodiments, surfactant may be added to an aqueous phase and the surfactants may form aggregates, such as spherical micelles, cylindrical micelles, lipid bilayers, and the like. Aggregate shape and size may be influenced by the chemical composition, structure, and amount of the surfactant. Fluorosurfactants have fluorocarbon chains. Siloxane surfactants have siloxane chains. Gemini surfactant molecules are dimeric structures and include two or more hydrophilic units and two or more hydrophobic units.

Aspects of the present disclosure relate to a filtration membrane for nanofiltration, particularly desalination. The filtration membrane may be applied for oil-water separation, organic solvent nanofiltration, wastewater treatment, removal of micropollutants, and the like. In one example, the filtration membrane was fabricated by tetraamine impregnation of a polysulfone (PSU) support matrix and reacted with terephthaloyl chloride (TCL) through interfacial polymerization (IP) to form a hyper-cross-linked polyamide thin film composite nanofiltration (HCPA-TFC-NF) membrane. The filtration membrane was characterized by CP-MAS ¹³C NMR, XPS, AFM, FTIR, EDX analysis, and elemental mapping. Filtration membrane features, such as surface morphology and hydrophilicity, were evaluated by FESEM and water contact angle measurements. FESEM analysis revealed formation of a uniform polyamide active layer on the surface of a PS/PET membrane support with a tunable pore structure dependent on curing time and curing temperature. The filtration membrane was further evaluated for desalination by using MgCl₂, CaCl₂, Na₂SO₄, MgSO₄, and NaCl as solutes with water as a solvent using crossflow filtration. When membrane fabrication was performed at 80° C. for 1 hour, MgCl₂ was rejected >97%. Treatment of the membrane with hydrofluoric acid showed a rejection of Erichrome black T (EBT) >99% with a permeate flux of 75 L m⁻² h⁻¹ (LMH).

According to an aspect of the present disclosure, a filtration membrane, also referred to as a membrane, is described. The filtration membrane includes a thermoplastic substrate. The thermoplastic substrate may be porous in nature, allowing, in some aspects, liquid to permeate. The thermoplastic substrate may have pores of 1 to 1500 nm, preferably 5 to 1000 nm, more preferably 10 to 500 nm, and yet more preferably about 20 to 100 nm in diameter. In some embodiments, a first layer and a second layer covers at least 50%, preferably 60%, more preferably 80%, and yet more preferably more than 95% of the surface of the support. Generally, the thermoplastic substrate should possess good mechanical and thermal properties. The thermoplastic substrate should demonstrate high resistance to chemicals such as aromatic hydrocarbons, ketones, ethers, and esters. The thermoplastic substrate is an aggregate material including a polymer component (thermoplastic polymer) configured to strengthen the membrane structure.

The thermoplastic substrate includes one or more thermoplastic polymers. Suitable examples of thermoplastic polymers include polypropylene (PP), polyamide (PA), polycarbonate (PC), high-density polyethylene (HDPE), low-density polyethylene (LDPE), polybutylene terephthalate (PBT), polyethylene terephthalate (PET), polystyrene (PS), polyether ether ketone (PEEK), polyphenylene sulfide (PPS), polyetherimide (PEI), polyamide-imide (PAI), acrylic (PAA), acrylonitrile butadiene styrene (ABS), polylactic acid (PLA), polyvinyl chloride (PVC), polyurethanes (PUR), polyvinylidene fluoride (PVDF), polytetrafluoroethylene (Teflon), and/or a mixture thereof. In a preferred embodiment, the thermoplastic polymer includes PET, more specifically, unwoven polyester terephthalate (PETP).

In some embodiments, the thermoplastic polymers may comprise one or more layers of thermoplastic polymers. Each layer may be made of the same thermoplastic polymer or a different thermoplastic polymer. In some embodiments, blends of thermoplastic polymers may be used as well. The thermoplastic substrate may be of varying thickness. The thermoplastic substrate may have a thickness of 10 to 5,000 μm, 50 to 4,000 μm, preferably 100 to 3000 μm, 250 to 2,000 μm and more preferably 500 to 1,000 μm.

In some embodiments, the thermoplastic substrate may be reinforced on a glass surface to impart greater mechanical/tensile strength to the membrane. In some embodiments, adhesives may be used to facilitate the fixing of one or more thermoplastic substrate to the surface. In an embodiment, the adhesive is a polyurethane adhesive. In certain other embodiments, the glass surface may optionally be surface activated by any of the methods conventionally known in the art, to facilitate the attachment of the thermoplastic substrate to the glass surface.

The membrane further includes a first layer including three components, namely a polysulfone, a polyvinylpyrrolidone, and a tetramine. Polysulfones are a group of polymers, including a sulfone group and alkyl- or aryl-groups. The polysulfone polymer may be polysulfone (PSU), polyethersulfone (PES), polyphenylene sulfone (PPSU), poly(arylene sulfone) (PAS), poly(bisphenol-A sulfone) (PSF), or some derivative of polysulfone. The polysulfone polymer may also be called a polyaryl sulfone or a polyarylethersulfone. The polysulfone polymer may also be called a polyaryl sulfone or a polyarylethersulfone. The polysulfone may be may be used alone or in combination with polymeric materials. Suitable polymers to be included in the first layer comprise, for example, polyvinylidene fluoride (PVDF), polytetrafluoroethylene (PTFE), polyacrylonitrile (PAN), poly(methyl methacrylate) (PMMA), poly(methacrylic acid) (PMAA), poly(acrylic acid) (PAA), poly(vinyl methyl ketone), poly(ether sulfone) (PSF), polyacrylonitrile (PAN), polypropylene (PP), polyimide (PI), and poly(arylene ether nitrile ketone) (PPENK), which can used alone or in combination with the polysulfone. In a preferred embodiment, the polysulfone polymer is polysulfone (PSU).

The first layer of the membrane further includes a second polymer of polyvinylpyrrolidone. In some embodiments, the first layer may further include copolymers of polyvinylpyrrolidone. Suitable examples of co-polymers include vinylpyrrolidone/vinylacetate copolymers, vinylpyrrolidone/vinylalcohol copolymers, vinylpyrrolidone/styrene copolymers, vinylpyrrolidone/dimethylaminoethyl methacrylate copolymers, modified polymers thereof, or the like, which may be used alone or in combination with the polyvinylpyrrolidone.

In some embodiments, other polymers such as polyvinyl chloride, polyvinylidene chloride, polyacrylonitrile, high impact polystyrene, acrylonitrile butadiene styrene, polyethylene/acrylonitrile butadiene styrene, polycarbonate/acrylonitrile butadiene styrene, acrylic polymers, polybutadiene, polyisoprene, polyacetylene, silicones, synthetic rubbers, and the like, and copolymers and mixtures thereof may be used as well instead of polyvinylpyrrolidine.

In one embodiment, the polysulfone polymer and the polyvinylpyrrolidine polymer each, independently, have a weight average molecular weight (MW) in a range of 2 to 3,000 kDa, preferably 5 to 2,000 kDa, preferably 10 to 1,000 kDa, preferably 10 to 800 kDa, preferably 15 to 500 kDa, and more preferably preferably 20 to 100 kDa. In one embodiment, the polysulfone polymer has a weight average molecular weight (MW) in a range of 1 to 3,000 kDa, preferably 5 to 1,000 kDa, preferably 10 to 100 kDa, preferably 20 to 60 kDa, preferably 25 to 50 kDa, preferably 30 to 40 kDa, or more preferably about 35 kDa. In one embodiment, the polyvinylpyrrolidine polymer has a weight average molecular weight (MW) in a range of 1 to 3,000 kDa, preferably 2 to 1,000 kDa, preferably 4 to 100 kDa, preferably 5 to 40 kDa, preferably 6 to 20 kDa, preferably 8 to 12 kDa, or more preferably about 10 kDa.

The degree of polymerization (DP) is defined as the number of monomeric units in a macromolecule or polymer. In one embodiment, the polysulfone (PSU) polymer and the polyvinylpyrrolidine (PVP) polymer each, independently, have a degree of polymerization in the range of 100-2500, preferably 150-1500, preferably 200-750, and more preferably 250-500.

The weight ratio of polysulfone to the polyvinylpyrrolidone is in a range of 1:1 to 20:1, preferably 3:1 to 18:1, preferably 5:1 to 15:1, preferably 7:1 to 12:1, preferably 9:1 to 11:1, and more preferably about 9:1. The polysulfone and the polyvinylpyrrolidone together form the polymer matrix in the first layer of the membrane. The polysulfone and the polyvinylpyrrolidone may be dissolved in a polar solvent to form a solution which may be cast onto the thermoplastic substrate. The thermoplastic substrate may be in the form of a sheet. To prepare a support of PSU/PET, the PSU and the PVP were mixed in a weight ratio of about 9:1 to obtain the support with desired chemical, mechanical, and thermal properties. Although the description herein refers to the use of PSU/PET support, it may be understood by a person skilled in the art that other polymeric supports may be used as well, albeit with a few variations, as may be evident to a person skilled in the art. The support and corresponding layers may be prepared by any of the conventional methods known in the art—for example, the phase inversion method or the electrostatic spinning method. In a preferred embodiment, the PSU/PET support is prepared by a modified phase inversion method. Phase inversion is a process in which membranes are fabricated. Phase inversion is performed by removing solvent from a liquid polymer solution, leaving a porous, solid membrane. Phase inversion may be carried out through reducing the temperature of the solution, immersing the polymer solution into an anti-solvent, exposing the polymer solution to a vapor of anti-solvent, evaporating the solvent in atmospheric air, evaporating the solvent at high temperature, and a combination thereof. A mean pore diameter and pore diameter distribution may be varied and dependent on a rate at which phase inversion occurs.

The first layer of the membrane further includes tetramine. The tetramine in the first layer is physically adsorbed and dispersed in the polymer matrix and the PSU/PET support. The tetraamine is physically adsorbed and/or dispersed to a depth of 0.5 to 5 μm, preferably 1 to 3 μm, of atop section of the first layer. The tetramine is physically adsorbed and/or dispersed in the top section of the first layer which is contact with the second layer. In some embodiments, the tetramine compound is a linear or branched aliphatic amine with 2-50 carbons and four amine groups. In some embodiments, the tetramine includes one or more primary amines and one or more secondary amines. In a preferred embodiment, the tetramine includes two primary amines and two secondary amines. In an embodiment, the tetramine is N,N′-bis(3-aminopropyl)ethylenediamine or N,N-bis(2-aminoethyl)-1,3-propanediamine. In a preferred embodiment, the tetramine is N,N′-bis(3-aminopropyl)ethylenediamine. The first layer, including the polymer matrix and the tetramine, is preferably in the form of vertical hollow tubes having a diameter of 0.1 to 10 μm, preferably 0.2 to 5 μm, and more preferably about 0.5 to 2 μm, and a length of 1 to 50 μm, preferably 2 to 40 μm, and more preferably about 5 to 20 μm. The vertical hollow tubes are defined by cylinders comprising the polymeric matrix and the pentaamine may vary in diameter and length depending on synthesis materials and conditions towards varying applications. The vertical hollow tubes comprising the polymeric matrix and the pentaamine may vary in size, distribution, and regularity depending on synthesis materials and conditions towards varying applications.

The membrane further includes a second layer that covers the vertical hollow tubes of the first layer. The second layer includes tetramine and reacted units of a phthaloyl chloride cross-linked with the tetramine to form a polyamide. In a preferred embodiment, the phthaloyl chloride is terephthaloyl chloride (TPC). The tetramine may be N,N′-bis(3-aminopropyl)ethylenediamine or N,N-bis(2-aminoethyl)-1,3-propanediamine, or a mixture thereof. In a preferred embodiment, the tetramine is N,N′-bis(3-aminopropyl)ethylenediamine. In some embodiments, the tetramine in the first layer and the second layer are different. In some embodiments, the tetramine in the first layer and the second layer are the same.

The tetramine covalently cross-links with the TPC during the interfacial polymerization process to form a polyamide (PA). Interfacial polymerization is a step-growth polymerization in which the polymerization occurs at the interface between two immiscible phases (generally two liquids), and the resulting polymer is constrained to the interface, comprising the interfacial layer. Variations of interfacial polymerization include, but are not limited to, polymer topologies of ultrathin films, nanocapsules, nanofibers, and the like. Interfacial polymerization may be used to prepare polyamides, polyanilines, polyimides, polyurethanes, polyureas, polypyrroles, polyesters, polycarbonates, and the like. During the interfacial polymerization process of the present disclosure, the tetramine in the second layer covalently cross-links with the reacted units of the phthaloyl chloride through at least one of a primary amine group and a secondary amine group of a first tetramine, and at least one of a primary amine group and a secondary amine group of a second tetramine to form the polyamide. In an embodiment, one or more primary amine groups of the first tetramine may be covalently crosslinked with terephthaloyl chloride to one or more primary amine groups of the second tetramine to form one or more polyamide linkages. In some embodiments, one or more primary amine groups of the first tetramine may be covalently crosslinked with terephthaloyl chloride to one or more secondary amine groups of the second tetramine to form one or more polyamide linkages. In an embodiment, one or more secondary amine groups of the first tetramine may be covalently crosslinked with terephthaloyl chloride to one or more primary amine groups of the second tetramine to form one or more polyamide linkages. In some embodiments, one or more secondary amine groups of the first tetramine may be covalently crosslinked with terephthaloyl chloride to one or more secondary amine groups of the second tetramine to form one or more polyamide linkages. In some embodiments, the first tetramine and the second tetramine(s) are covalently crosslinked with terephthaloyl chloride via a primary group and/or a secondary amine group of the first tetramine and a primary group and/or a secondary amine group of the second tetramine. The first tetramine and the second tetramine may be the same or different. In said embodiment, the first tetramine and the second tetramine is the N,N′-bis(3-aminopropyl)ethylenediamine. The current disclosure may include one or more and any combination of the above disclosed polyamide linkages, as well as polyamide linkages not specifically disclosed herein.

In a preferred embodiment, one or more carbon atoms of the one or more acyl groups of a diacyl compound, such as a phthaloyl chloride, is covalently bonded to one or more nitrogen atoms of the tetramines. In some embodiments, one or more carbon atoms of the one or more acyl groups of the diacyl compound may be covalently bonded to a primary amine group of the tetramine. In some embodiments, one or more carbon atoms of the one or more acyl groups of the diacyl compound may be covalently bonded to a secondary amine group of the tetramine. The tetramine may be covalently bonded to one or more carbon atoms of the one or more acyl groups of the diacyl compound. The distribution and thickness of the active layer is variable and dependent on the choice of the method, reaction conditions, and the concentration of the pentaamine and the TPC. In some embodiments, the tetramine in the second layer is covalently cross-linked with the reacted units of the phthaloyl chloride through at least one of a primary amine group and a secondary amine group of the first tetramine, and at least one of a primary amine group and a secondary amine group of the second tetramine to form the polyamide. The polyamide is a hyper-branched cross-linked matrix. The polyamide of the second layer may vary in thickness depending on synthesis materials and conditions towards varying applications. The second layer has a thickness of 0.1 to 10 μm, preferably 0.5 to 5 μm, and more preferably about 1 to 3 μm. The second layer may be in the form of nanoparticles with a diameter of 10 to 500 nm, preferably 20 to 300 nm, and more preferably about 50 to 200 nm.

Surface roughness is another parameter determining the performance of the membrane. Literature reveals that rougher surfaces tend to foul because of the accumulation of foulants in the valleys, which reduces the permeate quality and flow rate. The membrane of the present disclosure has an average surface roughness of 9 to 11 nm. The success of the fabrication process was determined based on the determining the water contact angle (WCA). Generally, if the WCA is less than 90°, the membrane is considered hydrophilic and if the WCA is larger than 90°, the membrane is considered hydrophobic. The WCA of the membrane of the present disclosure is in a range of 60° to 90°. The membrane has a rate of flux of 30 to 40 L m⁻² h⁻¹ at a pressure of 20 bar.

Elemental analysis reveals the successful fabrication of the membrane. The membrane includes carbon in an amount of 78 to 81%, preferably 79 to 80% by weight, oxygen in an amount of 10 to 13%, preferably 11 to 12% by weight, sulfur in an amount of 5 to 8%, preferably 6 to 7% by weight, and nitrogen in an amount of 1 to 4%, preferably 2 to 3%, by weight based on the total weight of the membrane.

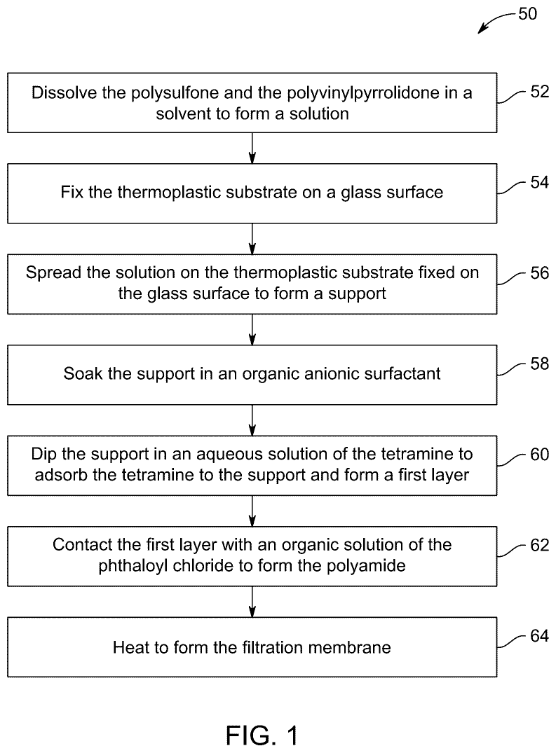

A method for making the membrane is described. Referring to FIG. 1, a schematic flow diagram of a method of making the membrane is illustrated. The order in which the method 50 is described is not intended to be construed as a limitation, and any number of the described method steps may be combined in any order to implement the method 50. Additionally, individual steps may be removed or skipped from the method 50 without departing from the spirit and scope of the present disclosure.

At step 52, the method 50 includes dissolving the polysulfone and the polyvinylpyrrolidone in a solvent to form a solution. Examples of polysulfones include PSU, PES, PPSU, PAS, PSF, or some derivative of polysulfone. The polysulfone polymer may also be called a polyaryl sulfone or a polyarylethersulfone. In a preferred embodiment, the polysulfone polymer is PSU. In some embodiments, other polymers such as polyvinyl chloride, polyvinylidene chloride, polyacrylonitrile, high impact polystyrene, acrylonitrile butadiene styrene, polyethylene/acrylonitrile butadiene styrene, polycarbonate/acrylonitrile butadiene styrene, acrylic polymers, polybutadiene, polyisoprene, polyacetylene, silicones, synthetic rubbers, and the like, and copolymers and mixtures thereof may be used as well instead of polyvinylpyrrolidine. Optionally, other polymers such as, poly(vinylidene) fluoride, poly(tetrafluoroethylene), poly(acrylonitrile), poly(methyl methacrylate), poly(methacrylic acid), poly(acrylic acid), poly(vinyl methyl ketone), and poly(ethylene terephthalate), polysulfone, polyethersulfone, poly(ether sulfone), polypropylene, polyimide, and poly(arylene ether nitrile ketone), alone or in combination, may be used as well. The weight ratio of polysulfone to the polyvinylpyrrolidone is in a range of 1:1 to 20:1, preferably 3:1 to 18:1, preferably 5:1 to 15:1, preferably 7:1 to 12:1, preferably 9:1 to 11:1, preferably about 9:1. The weight ratio of polysulfone and polyvinylpyrrolidone to the solvent is in a range of 1:1 to 1:10, preferably 1:2 to 1:8, preferably 1:3 to 1:5, and more preferably about 1:4.

Optionally, copolymers may be used along with polyvinylpyrrolidone. Suitable examples of copolymers include vinylpyrrolidone/vinylacetate copolymers, vinylpyrrolidone/vinylalcohol copolymers, vinylpyrrolidone/styrene copolymers, vinylpyrrolidone/dimethylaminoethyl methacrylate copolymers, modified polymers thereof, or the like.

The polysulfone and the polyvinylpyrrolidone are dissolved in a solvent to form the solution. As used herein, the term “solvent” refers to and includes, but is not limited to, water (e.g. tap water, distilled water, deionized water, deionized distilled water), organic solvents, such as ethers (e.g. diethyl ether, tetrahydrofuran, 1,4-dioxane, tetrahydropyran, t-butyl methyl ether, cyclopentyl methyl ether, di-iso-propyl ether), glycol ethers (e.g. 1,2-dimethoxyethane, diglyme, triglyme), alcohols (e.g. methanol, ethanol, trifluoroethanol, n-propanol, iso-propanol, n-butanol, i-butanol, t-butanol, n-pentanol, i-pentanol, 2-methyl-2-butanol, 2-trifluoromethyl-2-propanol, 2,3-dimethyl-2-butanol, 3-pentanol, 3-methyl-3-pentanol, 2-methyl-3-pentanol, 2-methyl-2-pentanol, 2,3-dimethyl-3-pentanol, 3-ethyl-3-pentanol, 2-methyl-2-hexanol, 3-hexanol, cyclopropylmethanol, cyclopropanol, cyclobutanol, cyclopentanol, cyclohexanol), aromatic solvents (e.g. benzene, o-xylene, m-xylene, p-xylene, mixtures of xylenes, toluene, mesitylene, anisole, 1,2-dimethoxybenzene, α,α,α-trifluoromethylbenzene, fluorobenzene), chlorinated solvents (e.g. chlorobenzene, dichloromethane, 1,2-dichloroethane, 1,1-dichloroethane, chloroform), ester solvents (e.g. ethyl acetate, propyl acetate), amide solvents (e.g. dimethylformamide, dimethylacetamide, N-methyl-2-pyrrolidone, formamide, N-formylmorpholine, N-methylformamide, 2-pyrrolidone, tetramethylurea, N-vinylacetamide), urea solvents, ketones (e.g. acetone, butanone), acetonitrile, propionitrile, butyronitrile, benzonitrile, dimethyl sulfoxide, ethylene carbonate, propylene carbonate, 1,3-dimethyl-3,4,5,6-tetrahydro-2(1H)-pyrimidinone, and mixtures thereof. As used herein, solvent may refer to non-polar solvents (e.g. hexane, benzene, toluene, diethyl ether, chloroform, 1,4-dioxane), polar aprotic solvents (e.g. ethyl acetate, tetrahydrofuran, dichloromethane, acetone, acetonitrile, dimethylformamide, dimethyl sulfoxide), polar protic solvents (e.g., acetic acid, n-butanol, isopropanol, n-propanol, ethanol, methanol, formic acid, water), and mixtures thereof. In one preferred embodiment, the solvent is an amide solvent. In a further embodiment, the solvent is dimethylacetamide, also written as N,N-dimethylacetamide. In one embodiment, the solvent is polar. In a preferred embodiment, the solvent is miscible with water.

The solution may be agitated for 0.5-3 hours, preferably 1-2 hours, and preferably about 2 hours. The agitation may encompass shaking, stirring, rotating, vibrating, sonication, and other means of agitating the solution. The solution may be heated at a temperature of 30-100° C., 35-87° C., 40-85° C., or 50-80° C., preferably 60-80° C., preferably 70-80° C., and more preferably 80° C. The solution may be agitated throughout the duration of the reaction by employing a rotary shaker, a magnetic stirrer, a centrifugal mixer, or an overhead stirrer. Alternatively, the mixture is left to stand (i.e., not agitated). The heating of the mixture may be carried out in a vacuum or under an inert gas such as N₂, Ar, and He. In a preferred embodiment, the solution is a homogenous mixture after agitation. In other embodiments, the solution may be a heterogenous mixture, suspension, and the like.

At step 54, the method 50 includes fixing the thermoplastic substrate on a glass surface. The thermoplastic substrate may be reinforced on a glass surface to impart greater mechanical/tensile strength to the membrane. In some embodiments, adhesives may be used to facilitate the fixing of the thermoplastic substrate to the glass surface. In an embodiment, the adhesive is a polyurethane adhesive. In certain other embodiments, the glass surface may optionally be surface activated by any of the methods conventionally known in the art, to facilitate the attachment of the thermoplastic substrate to the glass surface.

At step 56, the method 50 includes spreading the solution on the thermoplastic substrate fixed on the glass surface to form a support. The solution is uniformly spread on the thermoplastic substrate using methods known in the art. The solution may be spread using a doctor's blade or any other tools known in the art. The doctor's blade may have a slit size of 50 to 500 μm, preferably 100 to 200 μm, and more preferably about 100 μm.

At step 58, the method 50 includes soaking the support in an organic anionic surfactant. Specifically, the support was soaked in an aqueous solution, including the organic anionic surfactant. The organic anionic surfactant is used as a wetting agent or a surfactant to enhance wettability without altering the inherent characteristics of the support. Suitable examples of the organic anionic surfactant are sodium dodecyl sulfate (SDS), sodium dodecyl benzenesulfonate (SDBS), cetyltrimethylammonium bromide (CTAB), and sodium lauryl sulfate (SLS). In a preferred embodiment, the organic anionic surfactant is SDS. The organic anionic surfactant was used to activate the first material and enhance the wettability of the membrane. In some embodiments, the concentration of the organic anionic surfactant in the aqueous solution is in a range of 0.01-10 wt %, preferably 0.03-5 wt %, preferably 0.05-0.1 wt % based on the total weight of the aqueous solution. The immersion of the support into the aqueous solution can be carried out at room temperature, preferably at a temperature range of 20-37° C., more preferably 20-30° C., and more preferably 22-25° C.

At step 60, the method 50 includes dipping the support in an aqueous solution of the tetramine to adsorb the tetramine to the support and form the first layer. In an embodiment, the tetramine is N,N′-bis(3-aminopropyl)ethylenediamine or N,N-bis(2-aminoethyl)-1,3-propanediamine. In a preferred embodiment, the tetramine is N,N′-bis(3-aminopropyl)ethylenediamine. The support was dipped in the aqueous solution for a period of 5-30 minutes, preferably 10-20 minutes, more preferably for about 10 minutes, with intermittent or constant shaking, to form the first layer.

At step 62, the method 50 includes contacting the first layer with an organic solution of the phthaloyl chloride to form the polyamide. In an embodiment, the phthaloyl chloride is terepthaloyl chloride (TPC) which acts as a cross-linker. The TPC was dissolved in n-hexane to form the organic solution. The concentration of TPC in the n-hexane is in a range of 0.1-1, preferably 0.2-0.5, and more about preferably 0.2 wt/v %.

During this process, an interfacial polymerization (IP) reaction occurs where the tetramine in the second layer covalently cross-links with reacted units of the phthaloyl chloride to form a polyamide (PA). During the IP process, the tetramine in the second layer covalently cross-links with the reacted units of the phthaloyl chloride through at least one of a primary amine group and a secondary amine group of a first tetramine, and at least one of a primary amine group and a secondary amine group of a second tetramine to form the polyamide. The polyamide is a hyper-branched cross-linked matrix.

One of the factors that affect the performance of the membrane is the duration to which the complex is exposed to the cross-linker. In an embodiment, the complex may be dipped in the cross-linker solution for 1-5 minutes, preferably 1-3 minutes, more preferably about 1 minute to form the membrane. The excess hexane may then be washed to remove solvent or impurities, to form the polyamide.

At step 64, the method 50 includes heating to form the filtration membrane. The polyamide is further heated in an oven for a period of 20 to 120 minutes, preferably 30 to 100 minutes, and more preferably 60 to 90 minutes, at a temperature range of 50 to 120° C., preferably 60-100° C., preferably 70-90° C., more about preferably 80° C., to evaporate the solvents (n-hexane), resulting in the formation of the membrane.

Another aspect of the present disclosure describes a method of nanofiltration with the filtration membrane of the present disclosure. The method includes passing a composition through the filtration membrane. The method may optionally include contacting the filtration membrane with an aqueous acidic solution before passing the composition throught the filtration membrane. Suitable examples of the aqueous acidic solutions include, but are not limited to, lemon juice, vinegar, hydrochloric acid, hydrofluoric acid, acetic acid, and the like. In an embodiment, the aqueous acidic solution includes hydrofluoric acid. The composition is passed through the filtration membrane for 0.5 to 15 hours. The composition includes solvents and solutes. The solvents may comprise water, methanol, ethanol, and isopropanol. The solute may be a dye. Suitable examples of dyes include alkaline methylene blue, methylene blue, tetrazine, acid orange, phenolic phenol, bisphenol, 2,4 dichlorophenol, Congo red, toluene, chromium ions, bromate ions, eosin yellow, Eriochrome black T (EBT), and the like. In an embodiment, the solute is EBT. In some other embodiments, the solute is an ionic compound. Suitable examples of the ionic salt include MgCl₂, CaCl₂, MgSO₄, Na₂SO₄, NaCl, and/or a mixture thereof. In some embodiments, the solute is a pharmaceutically active compound. Pharmaceutically active compounds are a class of emerging environmental contaminants widely being used in human and veterinary medicine. The primary source of release of these substances and their metabolites into the environment is represented by domestic disposal and hospital sewage discharge. Suitable examples of pharmaceutically active compounds include cetaminophen, metoprolol, caffeine, antipyrine, sulfamethoxazole, flumequine, ketorolac, atrazine, isoproturon, 2-hydroxybiphenyl, diclofenac, amitriptyline, and loperamide. Certain other examples include, analgesics (for example, propoxyphene); anticonvulsants (for example: phenytoin); anti-depressants (for example, fluoxetine (Prozac), sertraline (Zoloft), amitriptyline, protriptyline, trimipramine maleate, nortriptyline, desipramine, imipramine, doxepin, nordoxepin, paroxetine); anti-inflammatory (for example, methyprednisolone, prednisone); hormones (for example, equilin, 17β-estradiol, estrone, 17α-ethynyl estradiol, medroxyprogesterone, megestrol acetate, mestranol, progesterone, norethindrone, norethynodrel, norgestrel, cholesterol); antibiotics (for example, norfloxacin, lincomycin, oxytetracycline HCl, ciprofloxacin, ofloxacin, trimethoprim, penicillin G. 1/2-benzathine salt, sulfamethoxazole, penicillin V potassium salt, tylosin tartrate).

On passing the composition through the membrane, the membrane selectively allows for the passage of the solvents leaving behind the solutes. The separation is based on size-exclusion phenomena. The method further includes collecting a permeate passed through the filtration membrane to obtain a purified composition having a reduced amount of solutes. Composition refers to a solution containing unwanted substances or impurities, or pollutants, or otherwise refers to a solution that affects the physical body, workplace, environment, or any experimental procedure. The composition includes a solvent and a pollutant. The pollutant may be a pharmaceutically active compound, dye, ionic salts, or a combination thereof. In some embodiments, the membrane has a rejection profile of solutes from 85 to 100% by weight.

### Examples

The following examples demonstrate the filtration membrane as described herein. The examples are provided solely for illustration and are not to be construed as limitations of the present disclosure, as many variations thereof are possible without departing from the spirit and scope of the present disclosure.

### Materials and Methods

N,N′-bis(3-aminopropyl)ethylenediamine 1 (97%), terephthaloyl chloride (TPC) 2 (99%), NaCl (99%), Na₂SO₄ (99%), MgCl₂ (98%), CaCl₂ (97%), MgSO₄ (99%), n-hexane (95%), triethylamine (TEA; 99%), polysulfone (PSf; PSU; 99%), dimethyl acetamide (DMAc; 99%), NaOH (98%), hydrofluoric (HF; 48%) acid, sodium dodecyl sulphate (SDS; 98.5%) and Eriochrome Black T (EBT) were purchased from Sigma Aldrich and polyester terephthalate (PET) supports were used as is without any further purification.

### Preparation of Hyper-Cross-Linked Polyamide HCPA-TFC-NF Membranes

The membranes were fabricated by following the general procedure reported in the literature [Zhao, Y., Zhang, Z., Dai, L. & Zhang, S. Preparation of high water flux and antifouling RO membranes using a novel diacyl chloride monomer with a phosphonate group. J. Memb. Sci. 536, 98-107 (2017), incorporated herein by reference in its entirety]. The polysulfone (PSU) dope/casting solution was prepared by adding 18.0 g of PSU and 2.0 g of polyvinylpyrrolidone (PVP) in 80.0 g of DMAc (202). The above mixture was stirred at 80° C. for 2 hours leading to the dissolution of PSU beads (204), and the resultant dope casting solution was allowed to stand at room temperature until all of the entrapped air bubbles escaped from the dope solution. Afterward, an appropriately sized piece of unwoven polyester terephthalate (PET) was fixed on a perfectly flat glass surface, and a thin film of PSU dope solution was spread on the PET by using a doctor's blade (100 μm slit size) (206). The polysulfone support membranes were fabricated by phase inversion technique using PET support. Then phase inversion was carried out where the PET support was added to the DI water coagulation bath (208). The phase inversion in the water bath resulted in PSU/PET support (210).

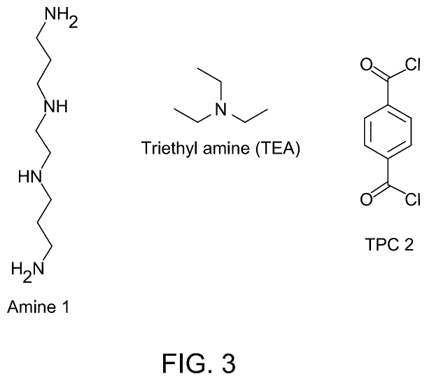

In order to increase the wettability of polysulfone support, it was soaked in 0.05% sodium dodecyl sulfate (SDS) aqueous solution (212) for 24 hours to form the SDS-treated PS@PET membrane support (214). For the fabrication of the active layer on the PSf support, IP was carried out. In this typical procedure, the PSf supports were fixed on a glass sheet, and then an aqueous solution (2% wt/v) of amine 1 (N, N′-bis(3-aminopropyl)ethylenediamine) containing a certain volume of triethylamine (TEA) was poured onto the PSf support, and it was impregnated for 10 minutes. The TEA was added as an HCl scavenger which is generated during the reaction of the amine 1 and TPC. After impregnation with amine 1, the excess amine was removed from the PSf support with the help of a rubber roller, and the membrane was allowed to dry in the air. Once the amine-impregnated support was dried, n-hexane solution (0.15%) of crosslinker 2 (terephthaloyl chloride; TPC) was poured onto the membrane, and the IP reaction was continued for 60 seconds leading to the formation of a hyper-cross-linked polyamide active layer resulting into the formation of HCPA-TFC-NF membrane (216). The excess crosslinker 2 was washed with n-hexane. The molecular structures of the reacting amine 1 and crosslinker 2, along with TEA, are given in FIG. 3, while the compositions of prepared solutions of amine 1 and crosslinker 2 (TPC) are as given in Table 1.

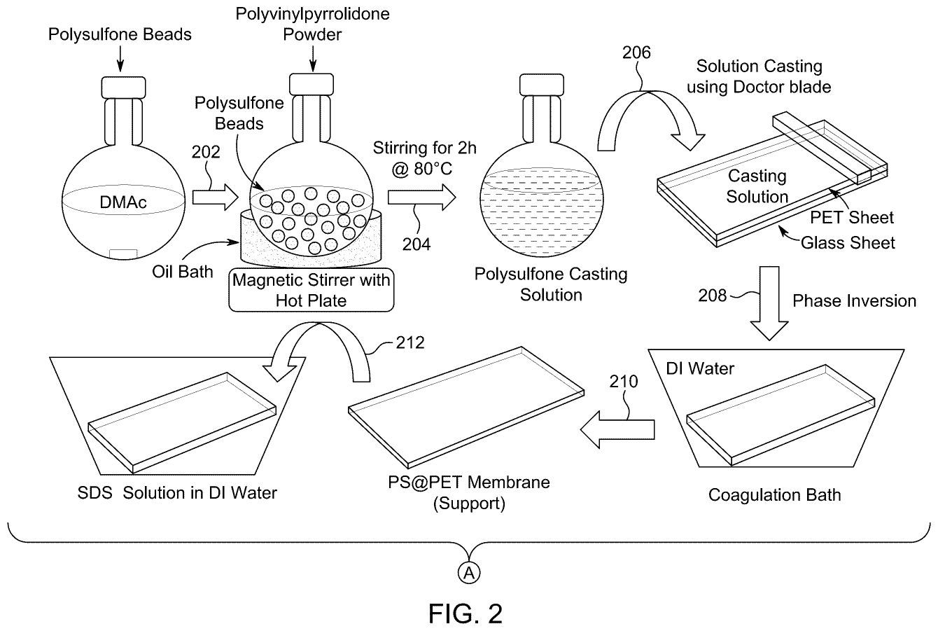

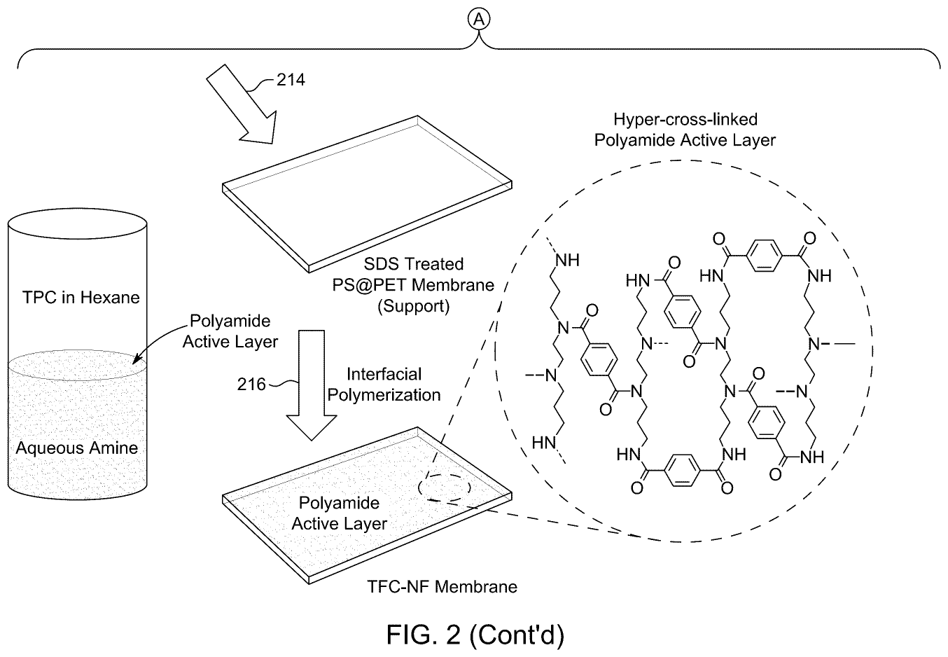

A free-standing active layer was also synthesized for the sake of characterization. For this purpose, solutions of amine 1 and TPC 2 were reacted in a vail, and the obtained white solid at the interface between the two phases was collected and washed thoroughly with both water and n-hexane alternatively. The washed active layer was completely dried before analysis. The various steps adopted during the fabrication of the HCPA-TFC-NF membrane are given in FIG. 2.

### Tailoring the Pore Structure of the Polyamide Active Layer by Varying the Curing Temperature of the Membrane

The successful IP resulted in the formation of a polyamide active (PA) layer on the PSf support. The membranes were exposed to various temperatures, such as 60° C., 80° C., and 100° C., in an air-drying oven to complete cross-linking.

### Tailoring the Pore Structure of the Polyamide Active Layer by Varying the Curing Time

The membranes were heated at different temperatures for different time intervals of 30, 60, and 90 minutes, respectively, and allowed to cool down to room temperature. Upon cooling, the obtained membranes were soaked in deionized water for 24 hours before starting the filtration experiments. The composition of the amine 1 and TPC 2 solutions are given in Table 1, along with the nomenclature of the fabricated membranes.

TABLE 1
The composition of amine 1 and TPC 2 solutions and other
studied parameters

| | Triethylamine | |
|---|---|---|
| Tetraamine | (TEA) in | |
| aqueous | aqueous amine | TPC in |
| solution | solution | n-hexane |
| Concentrations | | |
| 2% (wt/v) | 4% (v/v) | 0.15% (wt/v) |

| | Variation of | | |
|---|---|---|---|
| S. | Temperature | | Resultant |
| No. | (° C.) | Variation of Time (h) | Membranes |
| 1 | 60 | 0.5 | HCPA-TFC-NF |
| | | | @0.5 h |
| 2 | 80 | 1 | HCPA-TFC-NF |
| | | | @1.0 h |
| 3 | 100 | 1.5 | HCPA-TFC-NF |
| | | | @1.5 h |

Variation of Temperature (° C.) @ 0.5 h

| | | |
|---|---|---|
| 4 | 60 | HCPA-TFC-NF |
| | | @60° C. |
| 5 | 80 | HCPA-TFC-NF |
| | | @80° C. |
| 6 | 100 | HCPA-TFC-NF |
| | | @100° C. |

Variation of Temperature @ 1 h

| | | |
|---|---|---|
| 7 | 60 | HCPA-TFC-NF |
| | | @M1 |
| 8 | 80 | HCPA-TFC-NF |
| | | @M2 |
| 9 | 100 | HCPA-TFC-NF |
| | | @M3 |

### Tailoring the Membrane Structure and Performance by Hydrofluoric (HF) Acid Treatment

The best-performing membrane HCPA-TFC-NF@M2 was treated with 15% HF aqueous solution (v/v) by simple immersion method [Gonzilez Muñoz, M. P. et al. Hydrofluoric acid treatment for improved performance of a nanofiltration membrane. Desalination 191, 273-278 (2006), incorporated herein by reference in its entirety] by soaking the membrane for 120 hours, and then the membranes were rinsed with DI water and tested again through a cross-flow filtration setup.

Characterization of TFC-PA membranes

To ascertain the various functionalities originating due to cross-linking of the amine 1 and acyl chloride 2, Fourier Transform Infrared (FTIR, Nicolet iS50, Thermo Fisher Scientific, Waltham, MA, USA) spectroscopy was performed. The attenuated total reflectance (ATR) experiment was performed by scanning the membrane sheet in the attenuated total reflectance-Fourier transform infrared (ATR-FTIR) instrument.

An active layer was fabricated by reacting solutions of amine 1 and TPC 2 in the presence of TEA as an acid acceptor, and the solvents were discarded while the obtained white membranous solid was thoroughly washed with DI water and n-hexane, three times each, to remove any of the unreacted monomers and the foam type active layer was heated in the oven at 80° C. for 1 hour as this temperature was the best temperature for membrane fabrication. The obtained dried sample was loaded into the sample holder, and solid ¹³C NMR was recorded on a Bruker spectrometer (400 MHz, H-1 frequency) at a spinning rate of 8 kHz, CP (cross-polarization) contact time of 2 milliseconds, and delay time of 2 seconds.

The surface morphological features of hyper-cross-linked polyamide thin film composite nanofiltration (HCPA-TFC-NF) membranes were investigated by using Quatrro FESEM equipped with an EDX analyzer (Thermo Fisher Scientific, Waltham, MA, USA). The membrane samples were characterized after coating with gold. The hydrophilicity experiments were carried out by water contact angle (WCA) measuring using a goniometer (CA-Drop Shape Analyzer DSA100E, KRUSS, GmbH, Borsteler Chaussee 85, 22453 Hamburg, Germany). A perfectly dried membrane was fixed on a glass slide, and a water droplet (2 μL) was created and dropped on the surface of the membrane, and the contact angle was measured. Atomic force microscopy (AFM) was done on Agilent 5500 AFM, while X-ray photoelectron spectroscopy (XPS) analysis was carried out on VG Scientific ESCALAB MKII X-ray photoelectron spectrometer. The surface zeta potential of the membranes was measured by Malvern Zetasizer Nano ZS at different pH values.

### Nanofiltration Evaluation of the Membranes

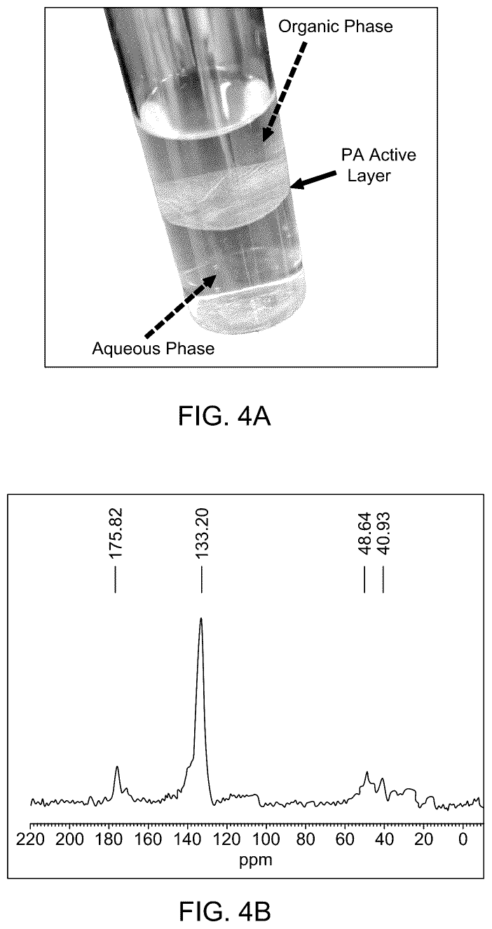

The permeance and flux of the membranes were tested by crossflow filtration experiments where DI water was used as feed. The flux is given by the following equation 1:

$$J = \frac{V}{A \times t} \qquad 1$$

where J represents flux (L m⁻² h⁻¹) of DI water, V represents the volume (L) of the permeate that has passed through the membrane, t is the time (h) taken by the permeate to pass through the membrane, A is the area (m²) of the membrane. The rejection of the solutes was calculated by the following equation 2:

$$R = ( \frac{{C}_{f} - {C}_{p}}{{C}_{f}} ) \times 100 \% \qquad 2$$

where Cₚ is the concentration of the solute in the permeate and C_{f} is the concentration of the solute in the feed solution. The concentration of the solutes was kept at 2 g L⁻¹ which was measured by conductivity meter (Ultrameter II). To further establish the structure and confirm the cross-linking success of the monomers 1 and 2 through interfacial polymerization (IP), cross-polarization magic angle spin (CP-MAS) experiments were performed to determine the solid ¹³C NMR of the polyamide active layer. To avoid the interference of the support layers, the polyamide active layer was fabricated in a vial, as shown in FIG. 4A. The peaks at 175.82 ppm indicate the carbonyl >C═O function of amide, while the peak at 133.20 ppm is attributed to the aromatic carbons of TPC. In comparison, the peaks at 48.64 and 40.93 ppm are due to the aliphatic carbons of the amine 1 (FIG. 4B). These peaks support the successful cross-linking and establishing of hyper-cross-linked polyamide active layer of HCPA-TFC-NF membrane.

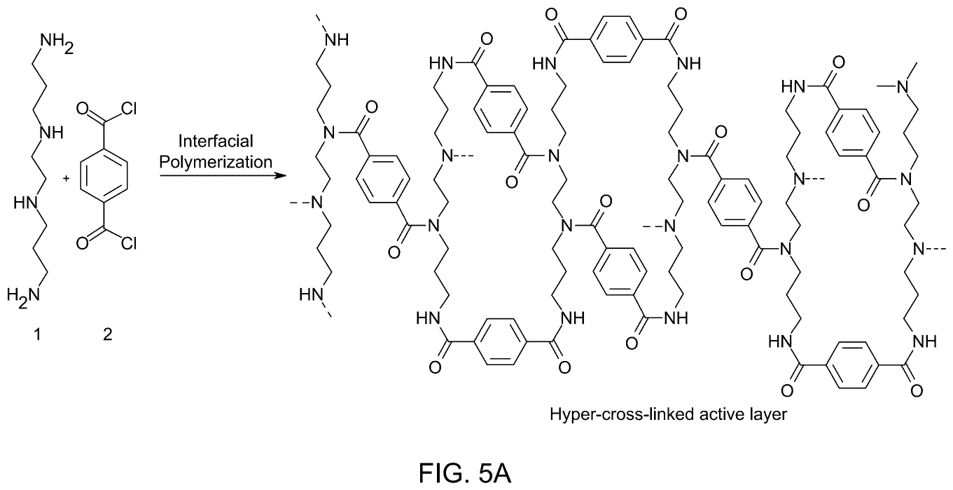

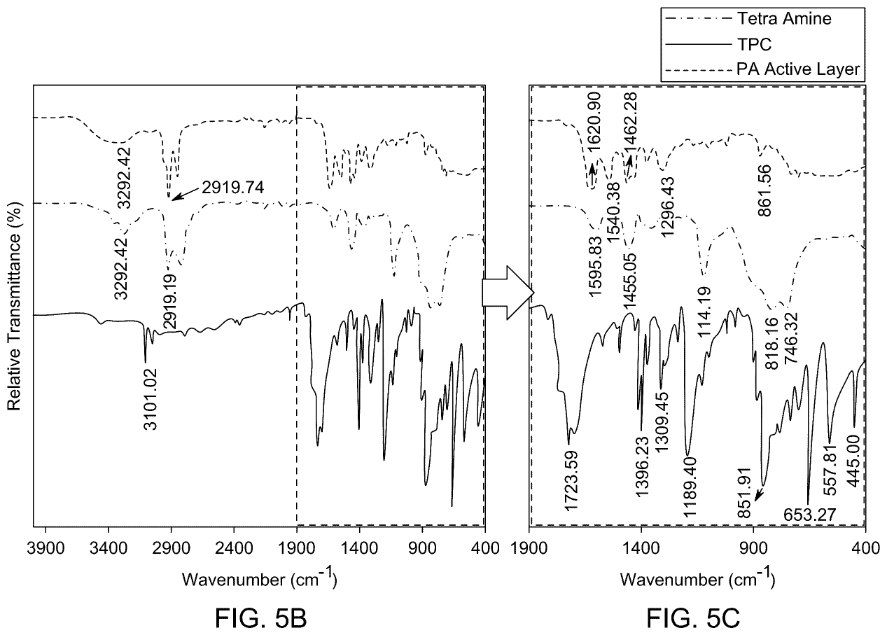

The presence of various functionalities in the active layer was confirmed by ATR-FTIR. The amide linkage (—CONH—), which confirms the success of the reaction between amine 1 and TPC, forms a polyamide active layer. It is evident from the spectrum of TPC that the peak at 3000 cm⁻¹ is indicative of ═C—H bond of the aromatic ring of the TPC while a strong peak at 1723 cm⁻¹ is representative of the carbonyl (>C═O) moiety of the acid chloride function. In the case of amine 1, the distinguishing peaks are a broad peak at 3292 cm⁻¹ and a narrow peak at 2919 cm⁻¹, which are attributed to the —N—H and aliphatic —C—H functions present in the amine structure, as shown in FIG. 5B. The spectrum of the hyper-cross-linked polyamide active layer possesses each of the characteristic peaks of the reacting amine 1 and TPC. A broad and strong peak in a region of 3600-3400 cm⁻¹ (FIG. 5B) is attributed to an amide —N—H bond. The peaks at 3000 cm⁻¹ to 2900 cm⁻¹ are due to the ═C—H and —C—H, which are attributed to aromatic functions and aliphatic chains present in the structure of the polyamide network. Furthermore, another characteristic narrow and strong peak is located at 1620 cm⁻¹ (FIG. 5C), which is due to the presence of carbonyl (>C═O) of amide linkage in the active layer. The presence of each of these peaks mentioned above, affirms the success of IP, leading to the formation of a hyper-cross-linked polyamide active layer, as indicated in the proposed structure of the active layer in FIG. 5A. A detailed account of all the characteristic peaks is given in the following Table 2.

TABLE 2
FTIR peaks assignment of pure tetramine 1, TPC 2, and freestanding PA active layer.

| FTIR peaks of | | FTIR peaks of | | FTIR peaks PA | |
|---|---|---|---|---|---|
| tetramine | | TPC | | active layer | |
| (Wavenumber) | Peaks | (Wavenumber) | Peaks | (Wavenumber) | Peaks |
| (cm⁻¹) | Assignment | (cm⁻¹) | Assignment | (cm⁻¹) | Assignment |
| 3292 | —N—H | 3000 | ═C—H bond | 3600-3400 | amide —N—H |
| | function | | of the | | bond |
| | present in | | aromatic | | present in |
| | the amine | | ring of the | | the structure |
| | structure | | TPC | | of the |
| | | | | | polyamide |
| | | | | | network |
| 2919 | Aliphatic - | 1723 | Carbonyl | 3000-2900 | ═C—H and |
| | C—H | | (>C═O) | | —C—H |
| | function | | moiety of | | present in |
| | present in | | the acid | | the structure |
| | the amine | | chloride | | of the |
| | structure | | function | | polyamide |
| | | | | | network |
| | | | | 1620 | Carbonyl |
| | | | | | (>C═O) of |
| | | | | | the amide |
| | | | | | linkage |

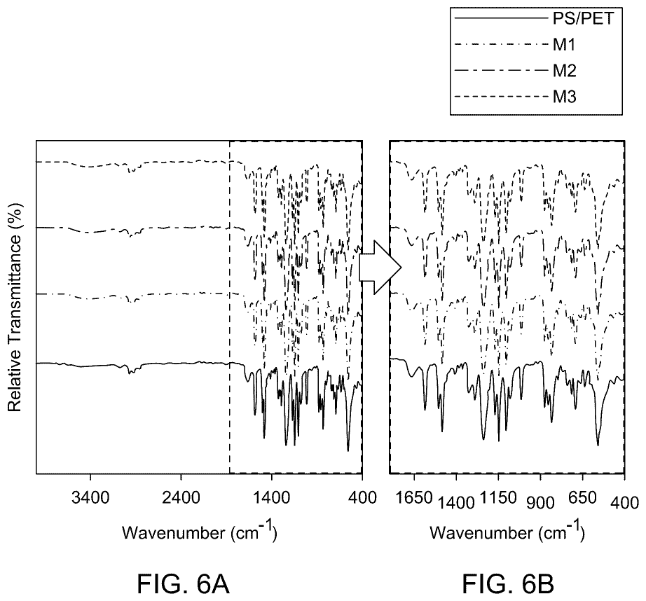

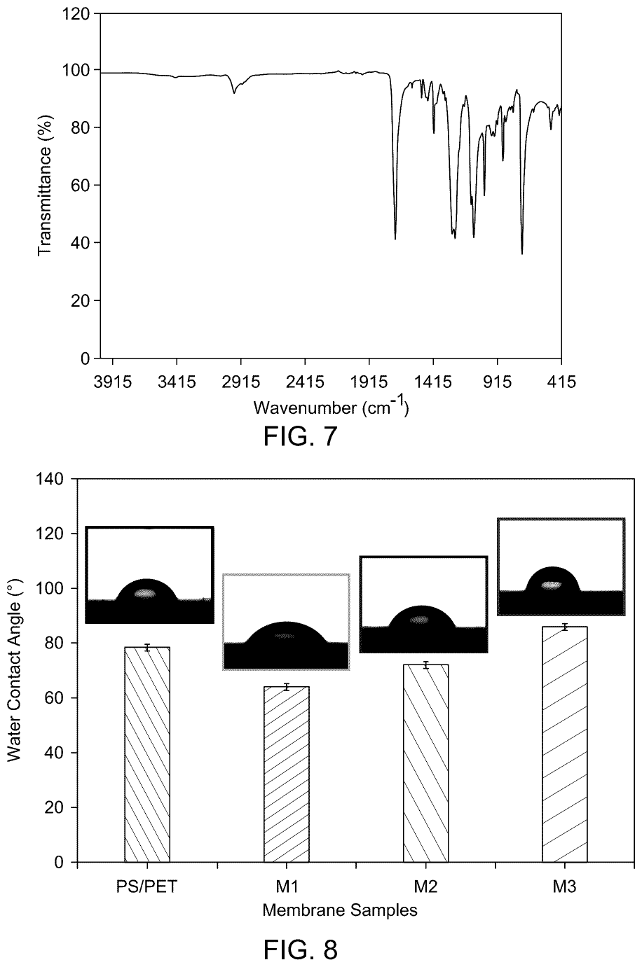

The ATR-FTIR of the PET support, PSf support, and the membranes HCPA-TFC-NF@M1, HCPA-TFC-NF@M2, and HCPA-TFC-NF@M3 are shown in the FIGS. 6A and 6B. It is visible that the PET (FIG. 7) lacks any peak in the amide —N—H region of 3600 cm⁻¹ to 3400 cm⁻¹, while a characteristic peak at 1600 cm⁻¹ is present in the case of PET due to ester linkage. Similarly, the PS/PET ATR-FTIR also lacks the peak characteristics of polyamide; however, the fabricated membranes show a broad band in the 3600-3400 cm⁻¹ range attributed to the amide —N—H linkage, while the >C═O frequency of the amide bond overlaps with >C═O of the support membrane. Hence, the interpretation of the FTIR of the support and TFC membranes shows that an active polyamide layer has been successfully grown on the support leading to HCPA-TFC-NF membranes. The intensity of the peaks of the hyper-cross-linked polyamide active layer is relatively lower, which can be attributed to a very thin nanometer-scale active layer, which may not be enough for the FTIR to show a significant profile. Hence, the FTIR of the free-standing active layer was measured where all of the required peaks are evident, as shown in FIG. 5B.

The surface wettability of the membranes was measured through water contact angle (WCA) measurements. The WCA of the support membranes was decreased upon the introduction of a polyamide active layer on the support, which is attributed to the presence of free amine functions and partially due to the carboxylic functions which are generated due to hydrolysis of the acyl chloride moieties of the TPC [Liu, S., Fang, F., Wu, J. & Zhang, K. The anti-biofouling properties of thin-film composite nanofiltration membranes grafted with biogenic silver nanoparticles. Desalination 375, 121-128 (2015), incorporated herein by reference in its eniterty]. the water contact angle showed the following increasing trend HCPA-TFC-NF@M1<HCPA-TFC-NF@M2<HCPA-TFC-NF@M3 with contact angles of 64.2°, 72.2° and 85.9°, respectively (FIG. 8). This can be attributed to an increased degree of crosslinking at higher temperatures leading to complete crosslinking of TPC with free amine functions. An extensive crosslinking of TPC leads to a decrease in the number of residual —COCl functions to be hydrolyzed into —COOH, a hydrophilic group. These observations are also reflected in the pattern of flux followed by the membranes. A higher water flux (50 L m⁻² h⁻¹ at 20 bar) was shown by HCPA-TFC-NF@M1 as it has the lowest WCA, while the lowest water flux (25.71 L m⁻² h⁻¹ at 20 bar) was found in the case of HCPA-TFC-NF@M3, as it has the larger WCA value. This observation is generally accepted where the decrease in WCA leads to increased hydrophilicity and higher flux of the membranes.

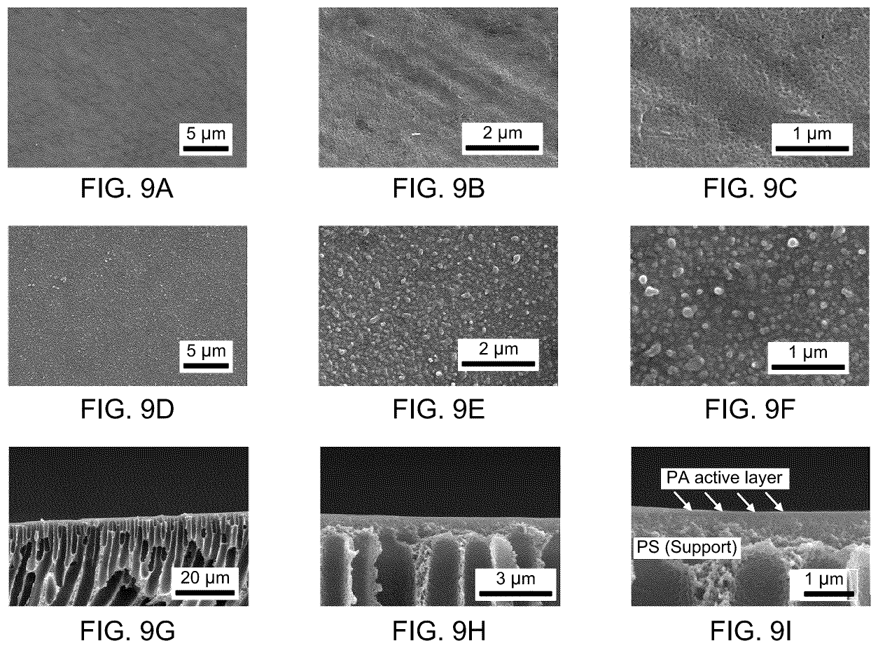

Field emission scanning electron microscopy (FESEM) was performed to reveal the morphological features of the membranes (FIG. 9). FIGS. 9A-9C shows FESEM images of the PS/PET support, while FIGS. 9D-9F shows FESEM images of the HCPA-TFC-NF@M2 membrane, at different magnifications. The roughness of the membranes can be seen in FIGS. 9D-9F, where it is visible that the PSf support is completely covered by a polyamide active layer, which shows that IP was not limited to the surface; instead, the porous nature of the support membrane has allowed amine 1 to diffuse deeper, and the polymerization has been taking place continuously from within the pores of the ultrafiltration PSf support leading to formation of a continuous polyamide active layer which has resulted into a selective membrane. The roughness shows a structure different from the traditional ridge and valley morphology of the MPD/TMC membrane.

To see the uniformity and intactness of PS/PET and HCPA-TFC-NF@M2, different magnifications of the support and HCPA-TFC-NF@M2 micrographs are shown in FIG. 9. FIGS. 9A-9C shows that the porosity of the membrane becomes visible as the magnification reaches 500 nm. It can be seen that the pores are uniformly distributed in the support with smooth surface features. However, the micrographs (FIGS. 9D-9F) of the HCPA-TFC-NF@M2 show that the pores of support are progressively covered by an active layer leading to the formation of a continuous hyper-cross-linked polyamide active layer on the support. Moreover, the globular appearance of the active layer (FIG. 9F) also confirms the extensive cross-linking leading to a polyamide network leading to a new membrane. Cross-sectional micrographs of the membranes at different magnifications were also shown in FIGS. 9G-9H. The cross-sections of the membrane revealed the formation of a highly dense skin layer of polyamide on the top, followed by highly porous support. The presence of finger-like projections in the ultrafiltration support provided the channels for the transport of permeate through the membrane.

The structure of the membrane active layer depends upon the kinetics and mechanism of IP. The TPC is a highly reactive bifunctional cross-linker that possesses acyl chloride on para-positions of the benzene ring. As trimesoyl chloride (TMC) is analogous in structure to TPC with the exception of a third acyl chloride; however, TMC is violently reactive at room temperature leading to the formation of a hyper-cross-linked polyamide active layer in conventional MPD or PIP/TMC membrane. Hence, the TPC being more soluble in hexane than TMC and possessing acyl chloride groups at para-positions make the diffusion and reaction of the TPC faster, leading to the formation of a hyper-cross-linked network with multifunctional amine 1. Amine 1, being aliphatic in nature, possesses a continuous chain-like structure with an equal ratio of primary (two —NH₂) and secondary amine (two —NH) groups which fulfills the requirement of hyper-crosslinking where at least one of the reacting monomers must be trifunctional, as amine 1 is tetrafunctional. These features of TPC 2 and amine 1 make these monomers ideal for fabricating a highly selective hyper-cross-linked polyamide active layer with a flux of 35.71 L m⁻² h⁻¹ and rejection of 87.36% for NaCl by HCPA-TFC-NF@M2 membrane at 20 bar.

Energy dispersive spectroscopy (EDS) results of the HCPA-TFC-NF@M2 membrane have revealed the presence of all of the essential elements, including nitrogen (N), carbon (C), oxygen (O), and sulfur (S) which are believed to be from polyamide active layer and PS/PET support membranes. The active layer is composed of polyamide, which possesses —CONH-linkages, while S is a component of PSf support, and the remaining elements are commonly found in each of the layers of the TFC membrane. The N is present in the case of HCPA-TFC-NF@M2 due to the formation of polyamide, while N is absent in the case of PS/PET support.

A lower percentage of N suggests that the active layer is comparatively narrower than the support PS/PET membranes. These findings confirmed the success of membrane fabrication and integrity of TFC membranes. Moreover, after the deposition of the active layer, the percentage of C and S is decreased while that of O is increased, which indicates that the thickness of the membrane has increased [Gonzilez Muñoz, M. P. et al. Hydrofluoric acid treatment for improved performance of a nanofiltration membrane. Desalination 191, 273-278 (2006); and Liu, S., Fang, F., Wu, J. & Zhang, K. The anti-biofouling properties of thin-film composite nanofiltration membranes grafted with biogenic silver nanoparticles. Desalination 375, 121-128 (2015), incorporated herein by reference in its entirety].

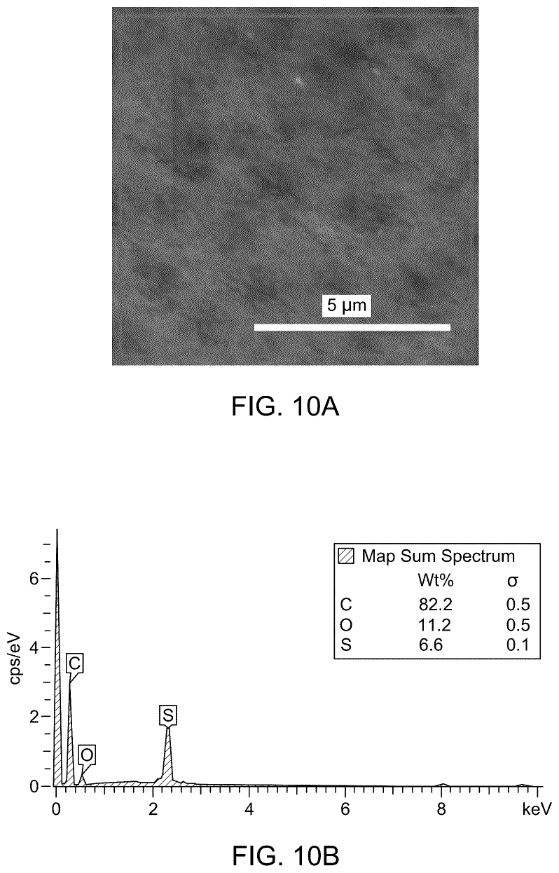

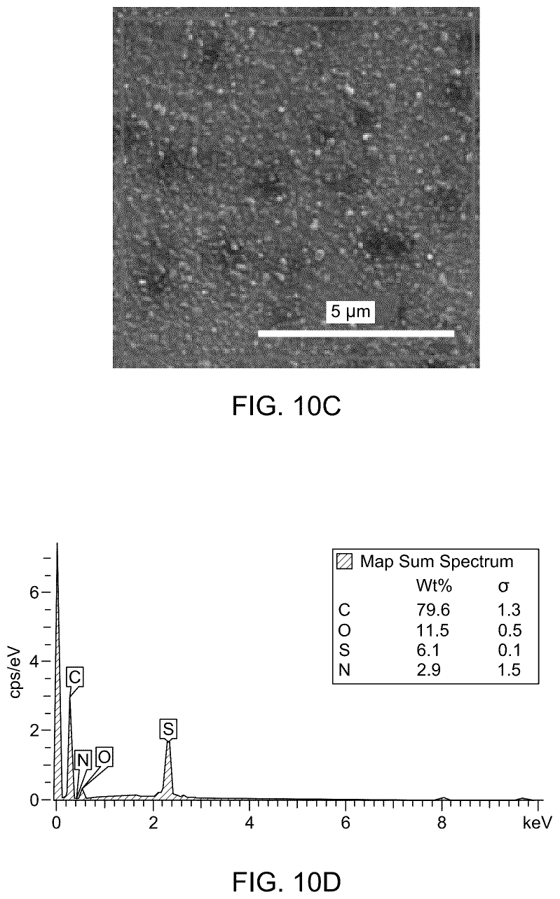

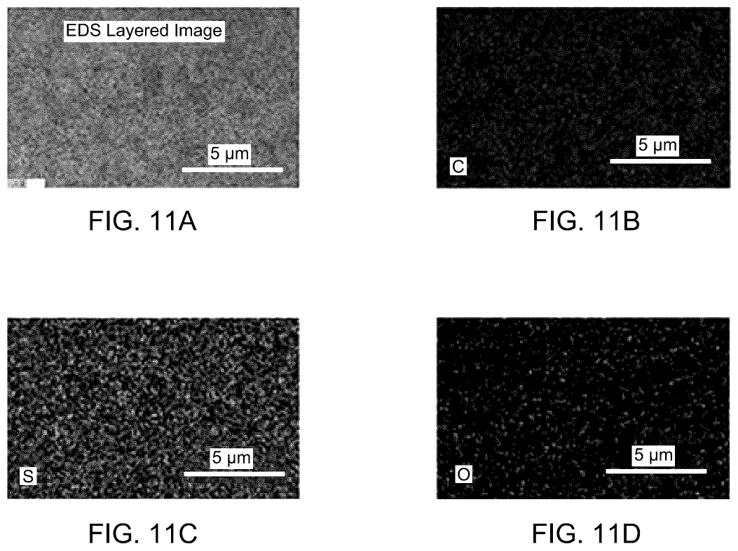

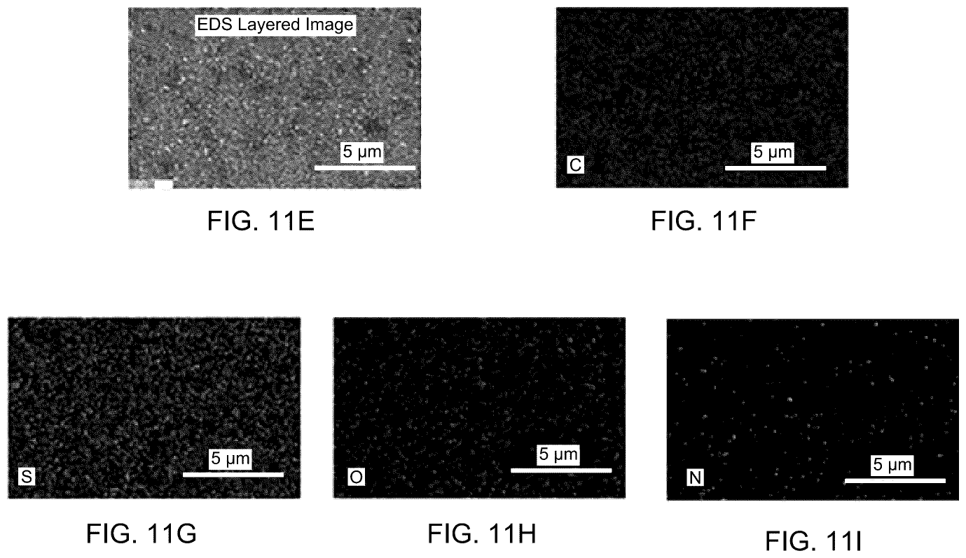

FIGS. 10A and 10B show FESEM-ED analysis of the PS/PET support, and FIGS. 10C and 10D show FESEM-EDS analysis of the HCPA-TFC-NF@M2 membrane. Elemental mapping results of the PS/PET support are shown below in FIGS. 11A-11D, where it is clearly evident that the support is composed of the elements namely C (FIG. 11B), O (FIG. 11D), and S (FIG. 11C). The mapping results show that each of the elements are equally distributed in PS/PET support, while in the case of HCPA-TFC-NF@M2, each of the elements, including C (FIG. 11F), O (FIG. 11H), and S (FIG. 11G) are present with equal distribution with an additional and equally distributed N element (FIG. 11I) which is due to amide bond of active layer [Lu, X. et al. Elements Provide a Clue: Nanoscale Characterization of Thin-Film Composite Polyamide Membranes. ACS Appl. Mater. Interfaces 7, 16917-16922 (2015), incorporated herein by reference in its entirety].

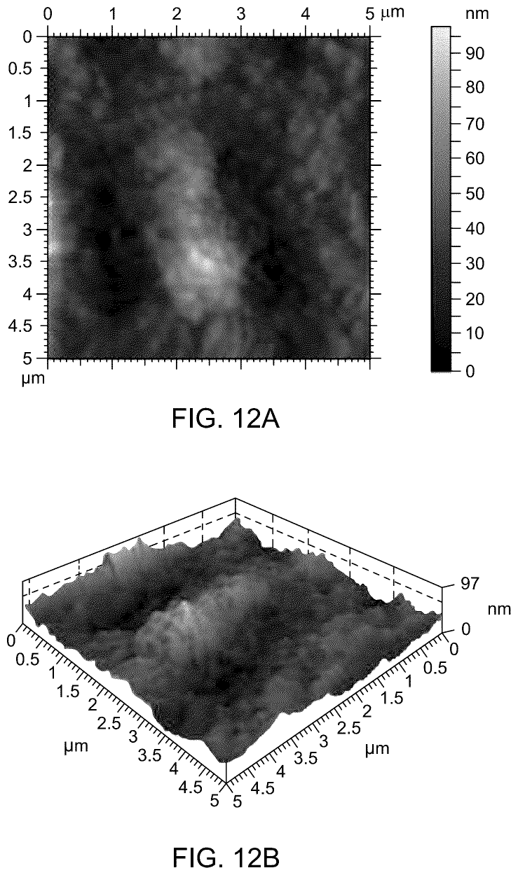

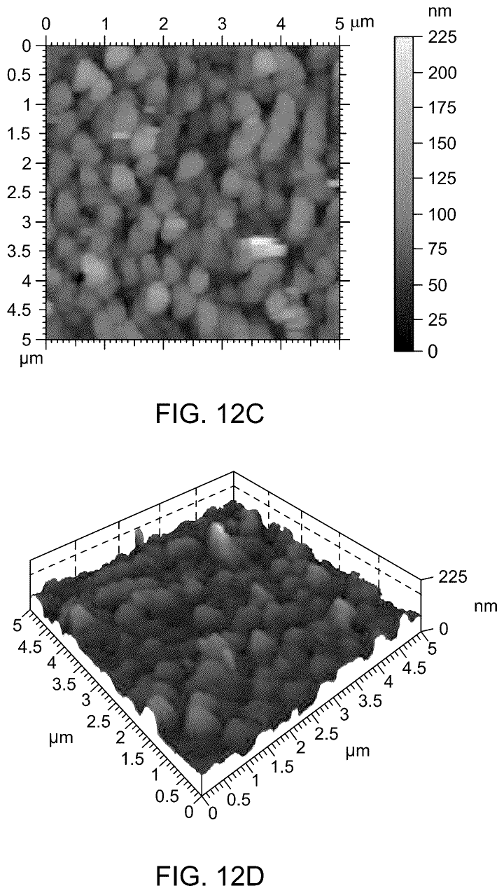

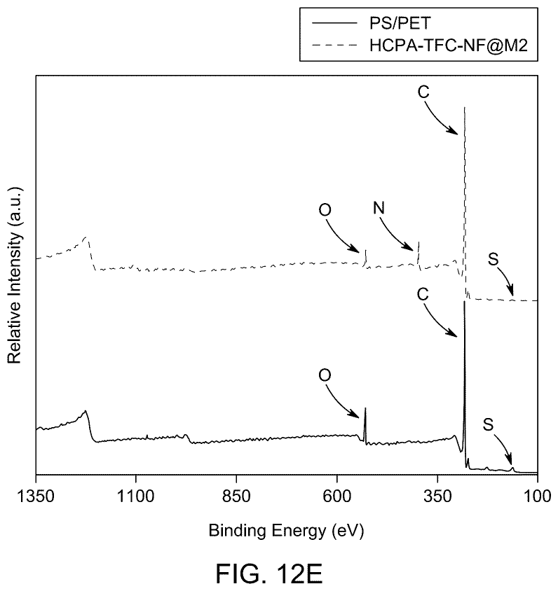

To get further insight into the surface features of fabricated membranes, AFM measurement was carried out, as shown in the following FIG. 12. The surface roughness of the bare PS/PET support (FIG. 12A and FIG. 12B) showed a relatively smoother surface compared to that of the HCPA-TFC-NF@M2 membrane (FIG. 12C and FIG. 12D). An increase in surface roughness after the deposition of polyamide active layer is an indication of formation of an active layer over the PS/PET support. The surface average roughness was increased from Rₐ=7.65 nm (PS/PET) to Rₐ=10.2 nm (HCPA-TFC-NF@M2) after the deposition of the polyamide active layer. The surface composition of the membranes was investigated, as shown in FIG. 12E.

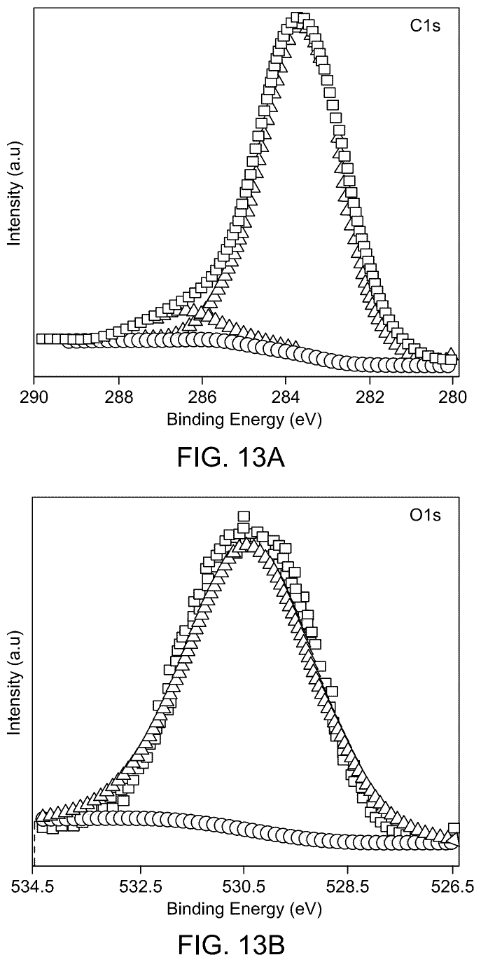

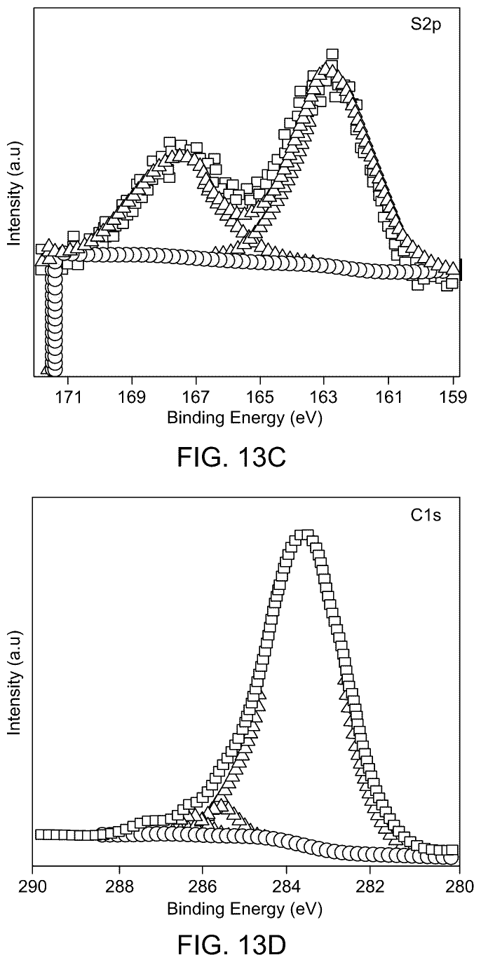

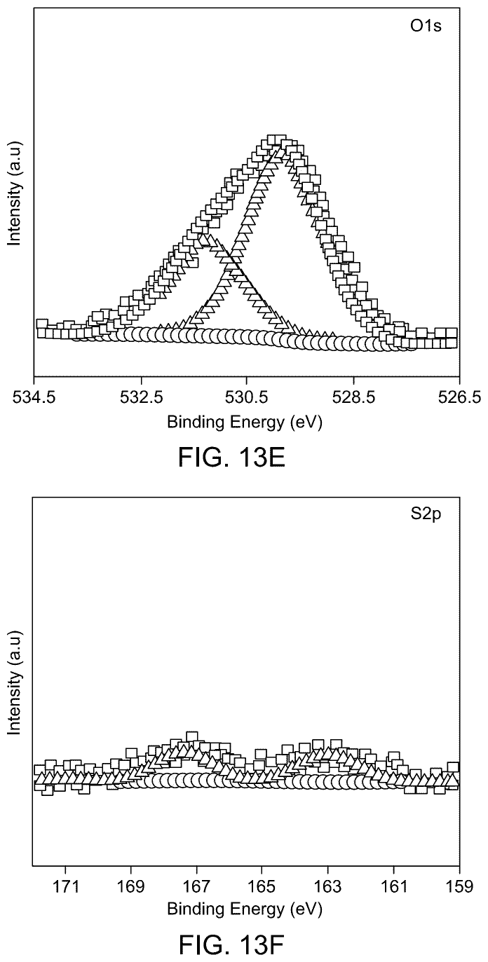

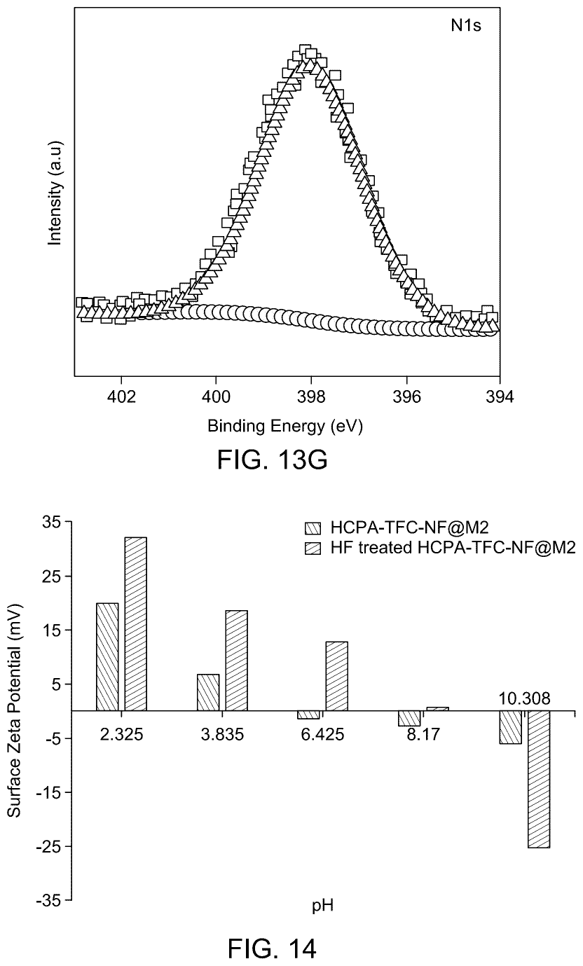

An XPS analysis of PS/PET support indicated the presence of constituent elements such as Carbon (CIs), Oxygen (O1s), and Sulfur (S2p), which are attributed to the PS/PET support, as can be observed in FIGS. 13A-13C, respectively. In the HCPA-TFC-NF@M2 membrane, an additional element, Nitrogen (N1s), was also found along with C1s (FIG. 13D), O1s (FIG. 13E), and S2p (FIG. 13F). The presence of N1s (FIG. 13G) indicated the presence of a polyamide network on the ultrafiltration support. Another observation was the suppression of the S1s peak, which might be attributed to the covering of the PS/PET support. These characterizations confirmed the successful formation of the polyamide active layer on PS/PET ultrafiltration support.

The high-resolution XPS spectra of the PS/PET support and the HCPA-TFC-NF@M2 membrane are given in FIG. 13. The deconvolution of the survey scan of PS/PET possesses two carbon peaks at 284.5 eV and 286.6 eV, which may be attributed to the C—C and C—S bonds of PSf (FIG. 13A). However, O1s showed a single peak at 530.5 eV, which may be attributed to the S═O bond of PSf (FIG. 13B). The deconvolution of the S2p peak showed the two peaks located at 163.2 eV and 168.1 eV due to S═C and S═O bonds of PSf. However, after the formation of the polyamide active layer, the carbon peak was split into three peaks located at 283.8 eV, 285.5 eV, and 286.3 eV, which might be attributed to C—C, C—N, and C═C bonds (FIG. 13C). The O1s peak was split into two distinct peaks at 529.5 eV and 531.5 eV, which were attributed to the carbonyl (C═O) bond of primary and secondary amide (—CONH) linkages of the active layer. The similar two S2p peaks were seen with a highly reduced intensity which indicated that the PS/PET support was fully covered by a polyamide active layer. The deconvolution of the Nis peak showed the presence of a single peak located at 398.4 eV, which confirmed the successful formation of a polyamide active layer.

The surface zeta potential of the membranes was measured as given in FIG. 14. It was found that at acidic pH, the HF-treated HCPA-TFC-NF@M2 was more positive than untreated HCPA-TFC-NF@M2. The HF-treated HCPA-TFC-NF@M2 showed a negative charge at a basic pH of 10.3, while untreated HCPA-TFC-NF@M2 showed a negative charge at pH 6.4. The isoelectric point for HF-treated membrane lies at a pH of about 8.3, while for untreated HCPA-TFC-NF@M2, it lies at about pH 6.0. This trend may be attributed to an excessive protonation of HCPA-TFC-NF@M2 due to acidic protons of HF, and deprotonation of HF-treated HCPA-TFC-NF@M2 needs stronger basic conditions. Due to the need for strong basic conditions for deprotonation, the HF-treated HCPA-TFC-NF@M2 showed a negative charge at pH >8.2. Moreover, the negative charge of HF-treated HCPA-TFC-NF@M2 is also more than the untreated HCPA-TFC-NF@M2.

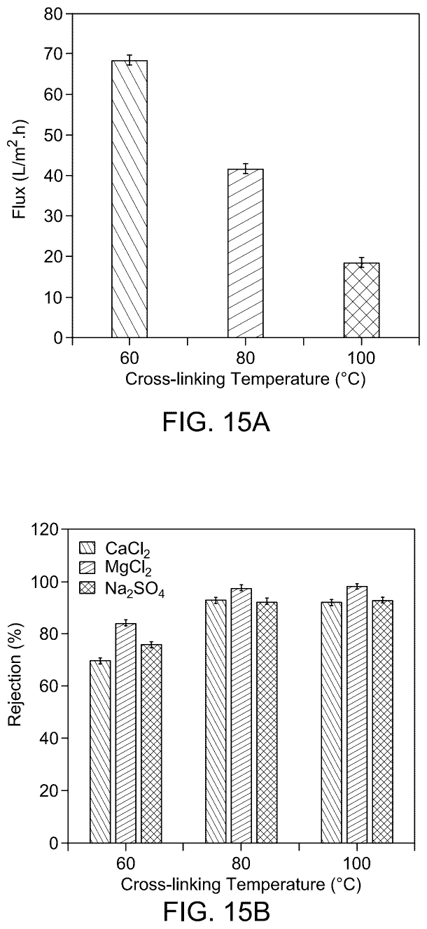

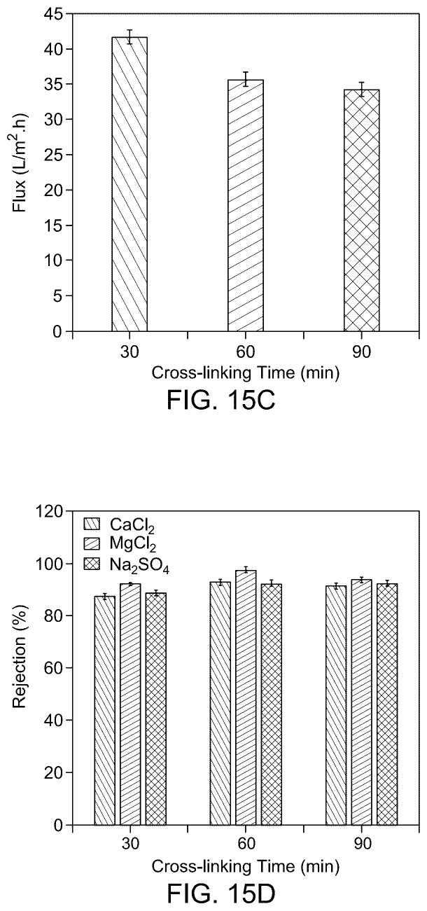

To determine the best conditions for the fabrication of a suitable membrane with reasonable flux and higher selectivity and with an idea of dependence of cross-linking on temperature, the study of the effect of different curing temperatures was conducted. The study was carried out by setting the curing temperature at three different values, including 60° C., 80° C., and 100° C., for a period of 30 minutes, as depicted in FIG. 15A. The membranes were named as HCPA-TFC-NF@60, HCPA-TFC-NF@80 and HCPA-TFC-NF@100, respectively. As seen in FIG. 15A, an increase in curing temperature led to a decrease in the flux of water, which can be attributed to increased cross-linking and dense polyamide active layer with the increasing temperature. Among the tested membranes, the highest flux was achieved in the case of HCPA-TFC-NF@60 reaching 68.57 L m⁻² h⁻¹, while the lowest flux was observed in the case of curing temperature of 100° C., HCPA-TFC-NF@100, with a value of 18.57 L m⁻² h⁻¹. A moderate value of flux (41.71 L m⁻² h⁻¹) was achieved in case of HCPA-TFC-NF@80.

The rejection of the salts, such as CaCl₂, MgCl₂, and Na₂SO₄, was studied at a feed concentration of 2 g L⁻¹. The conductivity and total dissolved solids (TDS) of both feed and permeate were measured, and the percent rejection of salts (FIG. 15B) was measured based on total dissolved solids (TDS) values by using equation 2. The highest salt rejection was attained in the case of 100° C. as a curing temperature, while the lowest rejection was observed in the case of 60° C. as the curing temperature. The fabricated membranes showed the highest rejection for MgCl₂, as is evident from FIG. 15B.

Based on the performance of the different membranes, the curing time was increased with an interval of 30 minutes each with values of 30, 60, and 90 minutes at a constant temperature of 80° C. The membranes were named HCPA-TFC-NF@0.5, HCPA-TFC-NF@1.0, and HCPA-TFC-NF@1.5, respectively. The flux was measured again at 20 bar, and it was observed that the highest flux (41.71 L m⁻² h⁻¹) was achieved for membrane cured for 30 minutes, HCPA-TFC-NF@0.5, while the lowest value of flux (34.28 L m⁻² h⁻¹) was obtained with a curing time of HCPA-TFC-NF@1.5. These observations suggest that the active layer has been densely hyper-cross-linked, resulting in fine pores and reduced flux. However, the curing time of 60 minutes was reasonable as the flux was found to be 35.71 L m⁻² h⁻¹ for HCPA-TFC-NF@1.0. A comparison of flux of the membranes at different curing times is depicted in FIG. 15C. The percent rejection of salt by the membranes was also studied, where the rejection of the tested salts stayed >85% for the fabricated membranes with the tested salts. The rejection was higher in the case of cross-linking at a time of 60 and 90 minutes of curing (FIG. 15D).

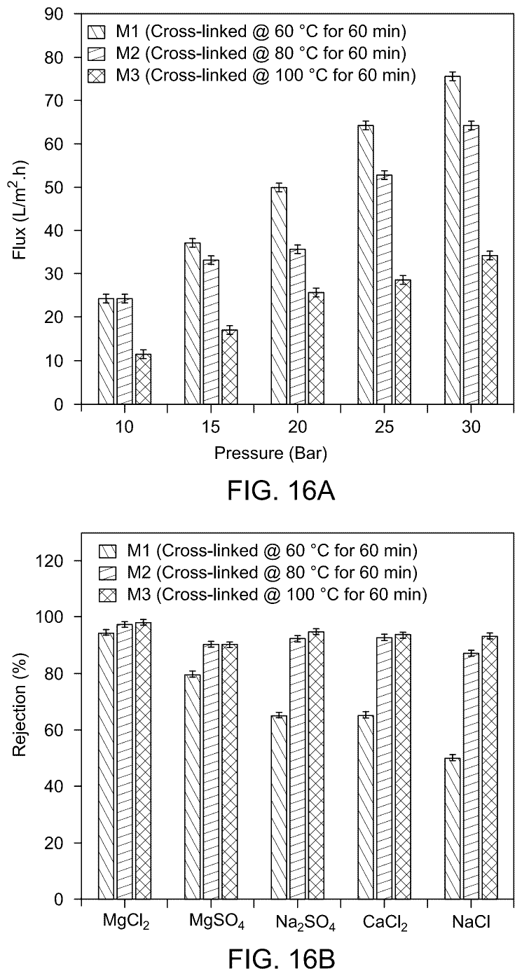

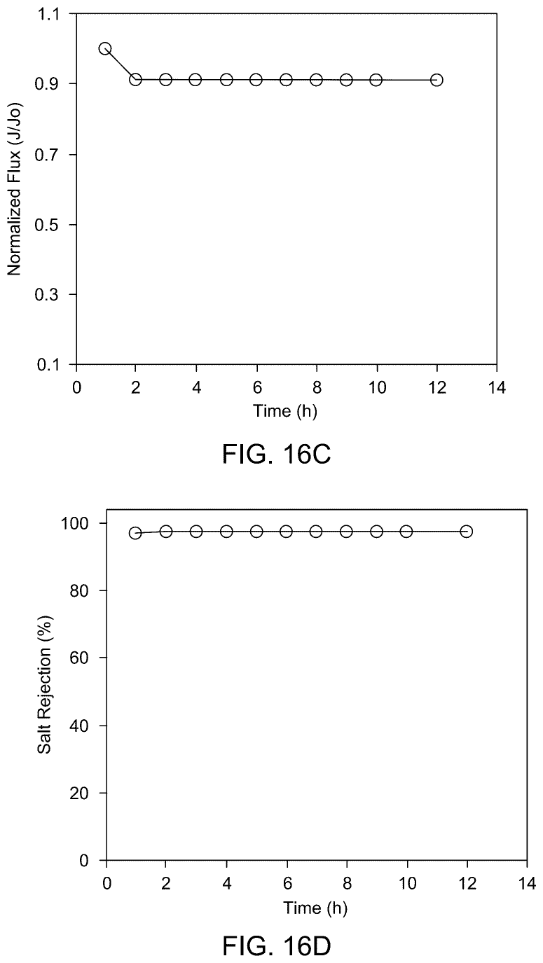

In pursuit of evaluation of the parameters for controlling the degree of hyper-crosslinking leading to the fabrication of excellently performing membranes and keeping the effect of curing time and curing temperature in mind, the membranes, namely HCPA-TFC-NF@M1, HCPA-TFC-NF@M2, and HCPA-TFC-NF@M3, were fabricated at three different temperatures 60° C., 80° C. and 100° C., with a curing time of 60 minutes. The flux of the tested membranes was measured at varied transmembrane pressures. It can be seen that the flux is linearly related to the applied transmembrane pressure, as shown in FIG. 16A.

The highest salt rejection was observed in the case of HCPA-TFC-NF@M3, while the lowest salt rejection was observed in the case of HCPA-TFC-NF@M1 for all of the tested salts, including NaCl. The highest salt rejection was observed in the case of MgCl₂ reaching a value of 98.11% in the case of HCPA-TFC-NF@M3, and it was found to be 97.45% in the case of HCPA-TFC-NF@M2 while the percent rejection of MgCl₂ was reduced to 94.59% in the case HCPA-TFC-NF@M1. These observations support the fact that as the degree of cross-linking increases, the membrane shows increased rejection. To find the best tradeoff agreement between the two rivals (flux and rejection), the best membrane was found to be HCPA-TFC-NF@M2 which was fabricated at 80° C. for 60 minutes (FIG. 16B).

The percent rejection of NaCl was found to be 87.36% and 93.28% in the case of HCPA-TFC-NF@M2 and HCPA-TFC-NFM3, respectively (FIG. 16B). Moreover, the fabricated membranes can tolerate higher values of transmembrane pressure, reaching up to 30 bar, which can again be attributed to the use of multiple amine sites available for cross-linking through TPC leading to the formation of strong hyper-cross-linked network. These features of rejecting NaCl and keeping the membrane integrity even at higher transmembrane pressures make such hyper-cross-linked membranes reverse osmosis (RO) like NF membranes. The coefficient of solute permeability (Bₑₓₚ.) was also determined based on concentration polarization by using the following equations, respectively.

$$k = \frac{{J}_{w , salt}}{ln [ \frac{Δ P}{{π}_{b} - {π}_{p}} ( 1 - \frac{{J}_{w , salt}}{{J}_{w , pure}} ) ]} \qquad 3$$

$${B}_{e x p} = {J}_{w} ( \frac{1 - {R}_{j}}{{R}_{j}} ) exp ( - \frac{{J}_{w}}{k} ) \qquad 4$$

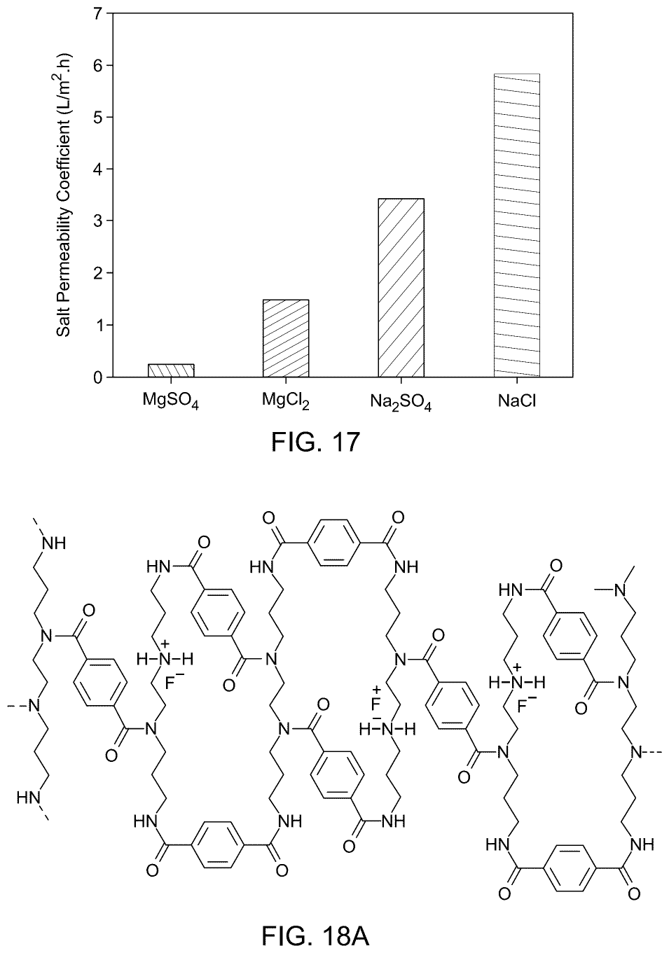

The solute permeability results are given in FIG. 17. It was observed that solute permeability increases as the ions change from divalent ions (Mg²⁺ and SO₄²⁻) to monovalent ions (Na¹⁺ and Cl⁻¹). MgSO₄ showed the lowest permeability (0.23 LMH), while NaCl was found to be the most permeable salt (5.8 LMH). The salts with a combination of monovalent and divalent ions (Na₂SO₄) showed a permeability of 3.5 (LMH; L m⁻² h⁻¹). This might be attributed to higher values of TDS (total dissolved solid) of NaCl compared to other salts, which under high pressure, get concentrated near the membrane surface. Given the higher concentration of NaCl near the membrane surface, it showed higher permeability than other salts.

In order to explore the stability of the HCPA-TFC-NF@M2 membrane, a long-term stability test was carried out where the membrane was able to maintain the rejection at a constant level. The flux was slightly decreased, which might be due to the deposition of some rust from the stainless steel filtration setup on the membrane surface (FIGS. 16C-16D).

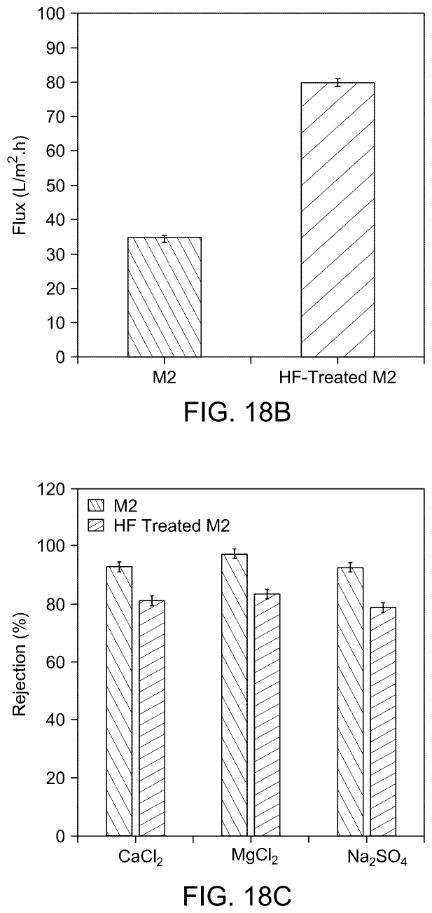

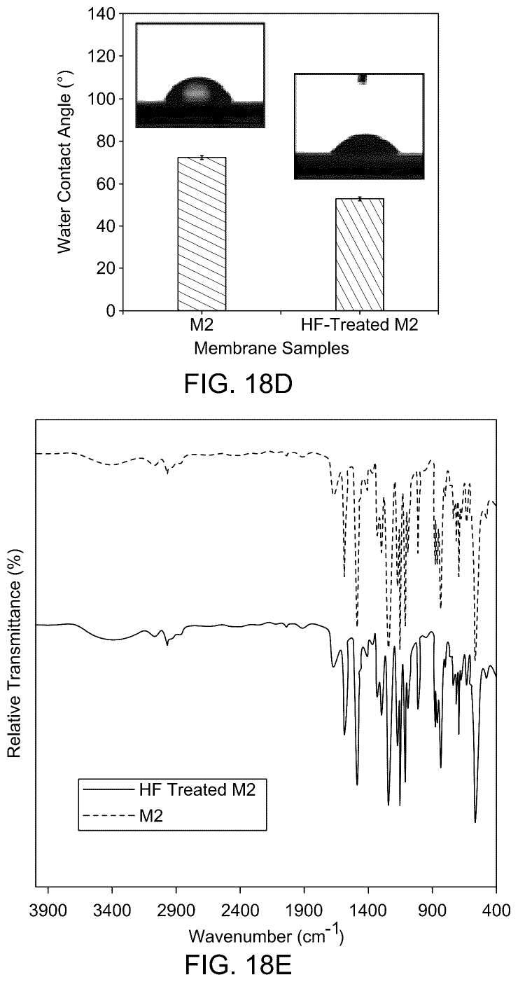

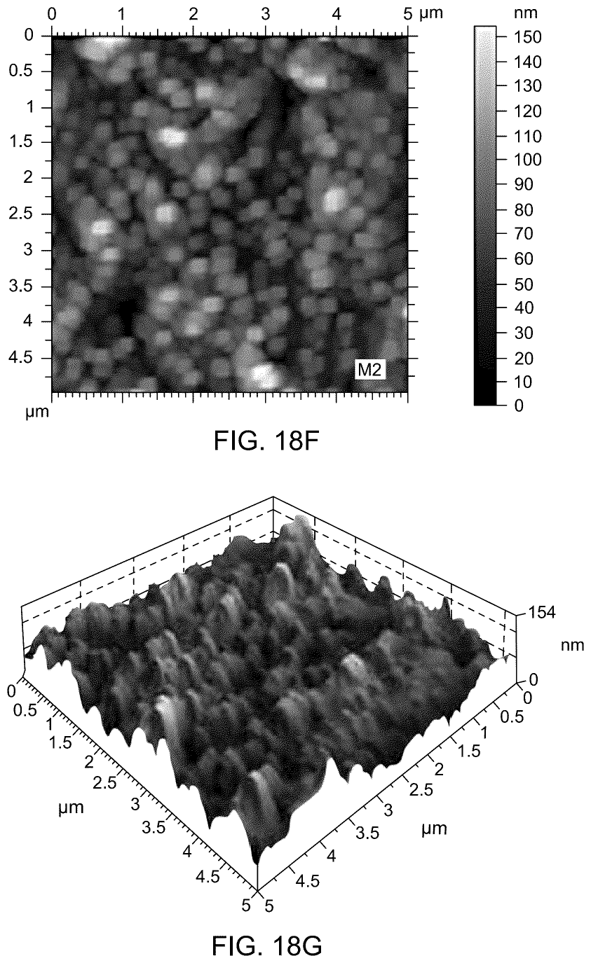

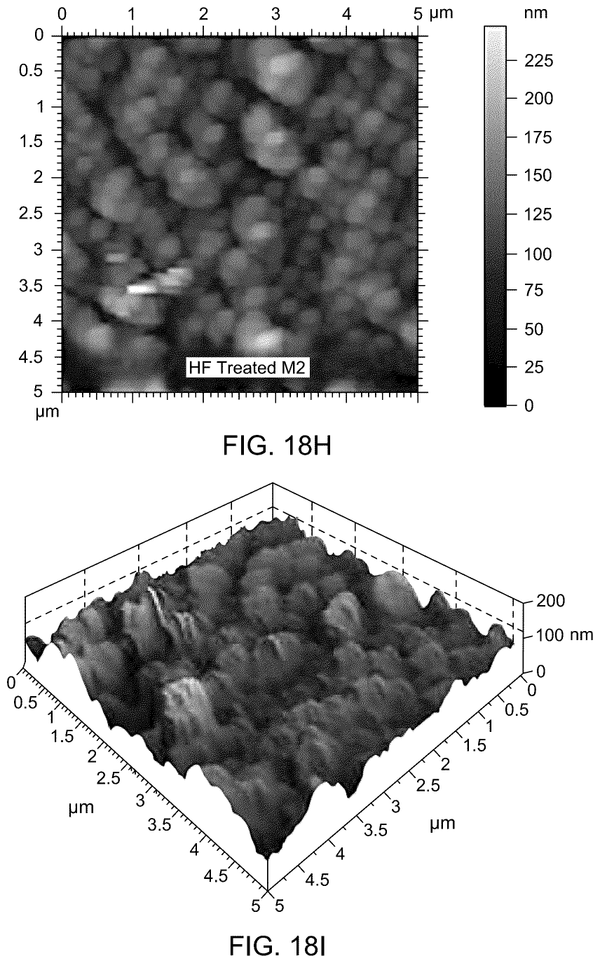

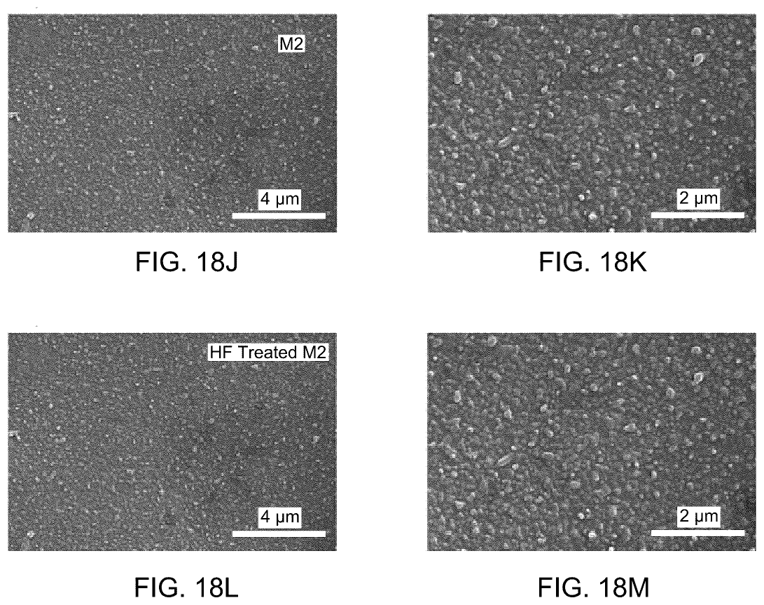

The HCPA-TFC-NF@M2 membrane was treated with 15% solution (v/v) of HF by simple immersion method. Compared to literature where the polyamide membranes have been exposed to lower concentrations of HF, such as 1% aqueous HF for a certain period of time, HCPA-TFC-NF@M2 has been immersed 15% aqueous HF solution for a period of 120 hours, allowing considerable reaction time. The HCPA-TFC-NF@M2 membrane was found to be visibly intact. As the polyamide active layer has been fabricated by using a multifunction amine and TPC, there is a possibility of the availability of unreacted amine function in the hyper-cross-linked polyamide network. The HF was added with the idea of protonation of the unreacted amine functions leading to the formation of ammonium ions in the polyamide network with fluoride as a counter anion, as depicted in the proposed structure of the active layer after HF treatment in FIG. 18A. The generation of ammonium ion function in the polyamide active layer leads to higher hydrophilicity without destroying the pore structure of the membrane, which results in higher flux compared to the untreated membrane. It can be seen that the flux was increased by more than double in the case of HF-treated HCPA-TFC-NF@M2 (80 L m⁻² h⁻¹) than untreated version of HCPA-TFC-NF@M2 (35.71 L m⁻² h⁻¹), as seen in FIG. 18B. The percent rejection was also maintained with a minor decrease after the treatment with HF, which indicates that the pore structure of the membrane has been intact after HF treatment (FIG. 18C).

To validate the assumption of an increase in hydrophilicity of the membrane after treatment with HF, the membrane was characterized for its hydrophilicity by measuring its WCA, which was considerably decreased from 72.22° to 52.29° (FIG. 18D). This decrease in WCA of the membrane after treatment with HF supports the observation of the higher flux of the membrane. Furthermore, the ATR-FTIR of the HF-treated membrane showed that the —N—H peak in the region of 3500 cm⁻¹ became stronger and broader than that of the untreated membrane, which can be attributed to the protonation of the free —N—H function as depicted in FIG. 18E. To further explore the intactness of HCPA-TFC-NF@M2 after exposure to HF, AFM and SEM analysis before and after exposure was conducted. Both 2D and 3D AFM images of HCPA-TFC-NF@M2 before (FIGS. 18F and 18G) and after (FIGS. 18H and 18I) HF treatment showed an intact membrane structure. Similarly, SEM analysis also revealed that the HCPA-TFC-NF@M2 membrane retained its integrity after HF treatment (FIGS. 18L and 18M). The FESEM micrographs of the HCPA-TFC-NF@M2 membrane are depicted in FIGS. 18J and 18K.

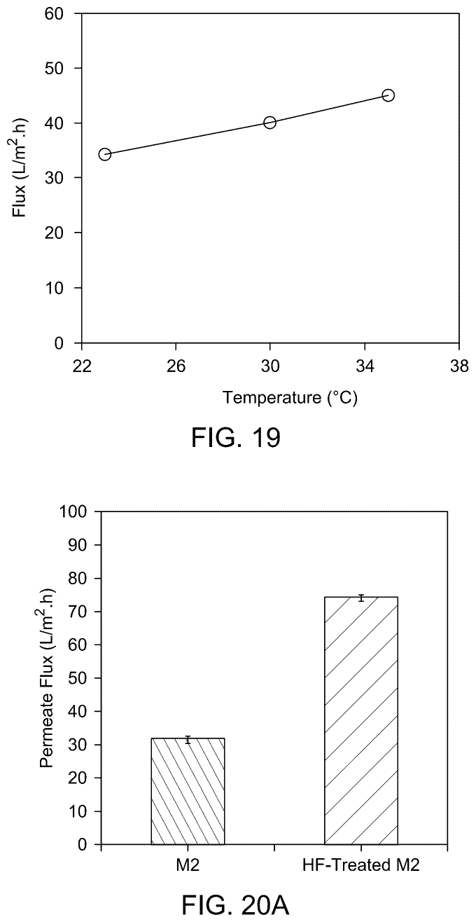

The integrity of the fabricated membrane HCPA-TFC-NF@M2 was explored by measuring the flux of the membrane at varied feed temperatures. The flux was found to increase with the increasing feed temperature (FIG. 19), which may be attributed to the increased mobility of the polyamide network chains allowing the easy diffusion of the water molecules through the membrane. Moreover, an increase in feed temperature also causes a decrease in the viscosity of the solution, leading to an increase in the mobility of water molecules through membrane channels.

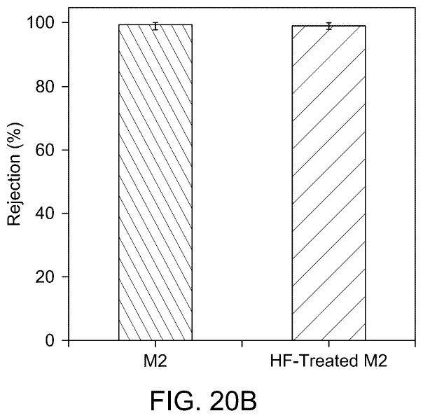

After success with the removal of salts from the feed solution, the membranes were applied for the removal of Eriochrome Black T (EBT) as a model organic pollutant from the feed solution. Both the membranes M2 and HF-treated M2 rejected >99% of EBT from the feed (FIG. 20B), while the permeate flux was retained as in previous experiments. The permeate flux was found to be more than double for HF-treated membrane compared to untreated M2 (FIG. 20A), which indicated that HF-treated M2 can be a candidate for treating a feed polluted with organic pollutants.

| | Chemicals used | | Rejection | Rejection | |
|---|---|---|---|---|---|
| | for IP and | Water | of | of | |
| | their reaction | Flux | divalent | monovalent | |
| Membranes | conditions | (L/m²h) | ions (%) | ions (%) | Ref. |
| Polyamide/ | 1% 1,3- | ~24 | ~85% | ~64% | [20] |
| PES | phenylenediamine | | | | |
| | and 0.2% | | | | |
| | Trimesoyl | | | | |
| | chloride | | | | |
| | (IP time = 60 s | | | | |
| | and Curing | | | | |
| | Temp = 60°) | | | | |
| Polyamide/ | 0.1% Trimesoyl | 23.7 | ~95% | ~40% | [21] |
| PSf | chloride and 1% | | | | |
| | Piperazine | | | | |
| | (IP time = | | | | |
| | 30 s and Curing | | | | |
| | Temp = 60°) | | | | |
| Polyamine/ | 1.0% | 4.15 | ~96.7% | ~61.2% | [22] |
| PSf | Polyvinylamine | | | | |
| | with 0.08% | | | | |
| | Isophthaloyl | | | | |
| | chloride | | | | |
| | (IP time = 20 s) | | | | |
| Polyamide/ | 0.3% Trimesoyl | 16 | ~96% | ~68.14% | [23] |
| PVDF | chloride and 2% | | | | |
| | Phenylenediamine | | | | |
| | (IP time = 60 s | | | | |
| | and Curing | | | | |
| | Temp = 60°) | | | | |
| Polyamide/ | 0.15% Trimesoyl | 1.93 | ~95.1% | ~35.5% | [24] |
| PES | chloride and 2% | | | | |
| | Piperazine IP | | | | |
| | time = 60 s and | | | | |
| | Curing Temp = | | | | |
| | 60°) | | | | |
| Polyamide/ | 0.2% Trimesoyl | ~20 | ~95% | — | [24] |
| PSf | chloride and 2% | | | | |
| | Piperazine | | | | |
| | (IP time = 60 s | | | | |
| | and Curing | | | | |
| | Temp = 60°) | | | | |
| Hyper- | 2% N,N′-bis(3- | ~35.71 | ~97.45% | ~87.36% | This |
| cross- | aminopropyl) | | | | Work |
| linked | ethylenediamine | | | | |
| Polyamide/ | (tetramine) and | | | | |
| PSf | 0.15% | | | | |
| | terephthaloyl | | | | |
| | chloride | | | | |
| | (IP time = 80 s | | | | |
| | and Curing | | | | |
| | Temp = 60°) | | | | |

Reference [20] corresponds to Wang, L. et al. Salt and Water Transport in Reverse Osmosis Membranes: Beyond the Solution-Diffusion Model. Environ. Sci. Technol. 55, 16665-16675 (2021); reference [21] corresponds toGonzález, M. P. et al. Effect of phosphoric and hydrofluoric acid on the structure and permeation of a nanofiltration membrane. J. Memb. Sci. 281, 177-185 (2006); reference [22] corresponds to Organic Nitrogen Compounds V: Amine Salts. https://www.spectroscopyonline.com/view/organic-nitrogen-compounds-v-amine-salts; reference [23] corresponds to Xu, R. et al. Influence of L-lysine on the permeation and antifouling performance of polyamide thin film composite reverse osmosis membranes. RSC Adv. 8, 25236-25247 (2018); reference [24] corresponds to Kamaly, N., Yameen, B., Wu, J. & Farokhzad, O. C. Degradable controlled-release polymers and polymeric nanoparticles: Mechanisms of controlling drug release. Chem. Rev. 116, 2602-2663 (2016), each of whichare incorporated herein by reference in its entirety.

To summarize, HCPA-TFC-NF membranes were prepared using multifunctional aliphatic amine possessing two primary and two secondary amine reaction sites in a single molecule and terephthaloyl chloride as a linear cross-linker. The choice of these monomers led to the successful fabrication of NF membranes with promising salt rejection and flux. The influence of curing temperature and curing time was also studied, where 80° C. and 60 minutes were found to be the best curing temperature and curing time for membrane fabrication. The resulting membrane HCPA-TFC-NF@M2 showed rejection for MgCl₂ and NaCl, reaching 97.45% and 87.36%, respectively, with a water flux of 35.71 L m⁻² h⁻¹. The HCPA-TFC-NF@M2 showed a rejection of >99% for EBT. Moreover, these membranes can tolerate relatively higher transmembrane pressure without losing performance in terms of rejection and flux, which makes these membranes applicable for treating the feed before passing it to reverse osmosis membranes. The HF treatment enhanced the nanofiltration performance of the membrane. The long-term stability test revealed that salt rejection by HCPA-TFC-NF@M2 membrane stayed almost constant during filtration experiments for 14 hours.

Numerous modifications and variations of the present invention are possible in light of the above teachings. It is, therefore, to be understood that, within the scope of the appended claims, the invention may be practiced otherwise than as specifically described herein.

1: A filtration membrane, comprising, in the following order:
a thermoplastic substrate,
a first layer comprising a polysulfone, a polyvinylpyrrolidone, and a tetramine,
a second layer comprising the tetramine and reacted units of a phthaloyl chloride cross-linked with the tetramine to form a polyamide.

2: The filtration membrane of claim 1, wherein the tetramine in the second layer is physically adsorbed and dispersed in the polysulfone and the polyvinylpyrrolidone.

3: The filtration membrane of claim 1, wherein the tetramine in the second layer is covalently cross-linked with reacted units of the phthaloyl chloride through at least one of a primary amine group and a secondary amine group of a first tetramine and at least one of a primary amine group and a secondary amine group of a second tetramine.

4: The filtration membrane of claim 1, wherein the polyamide in the second layer is in the form of a hyper-branched cross-linked matrix.

5: The filtration membrane of claim 1, wherein the tetramine is N,N′-bis(3-aminopropyl)ethylenediamine.

6: The filtration membrane of claim 1, wherein the second layer is in the form of nanoparticles with a diameter of 10 to 500 nm.

7: The filtration membrane of claim 1, wherein the first layer is in the form of vertical hollow tubes having a diameter of 0.1 to 10 μm and a length of 1 to 50 μm.

8: The filtration membrane of claim 1, wherein the second layer covers the vertical hollow tubes of the first layer.

9: The filtration membrane of claim 1, wherein the second layer has a thickness of 0.1 to 10 μm.

10: The filtration membrane of claim 1, having a water contact angle is from 60 to 900.

11: The filtration membrane of claim 1, comprising carbon in an amount of 78 to 81% by weight, oxygen in an amount of 10 to 13% by weight, sulfur in an amount of 5 to 7% by weight, and nitrogen in an amount of 2 to 4% by weight based on a total weight of the membrane.

12: The filtration membrane of claim 1, wherein a surface roughness is from 9 to 11 nm.

13: The filtration membrane of claim 1, wherein the membrane has a rate of flux of 30 to 40 L m⁻² h⁻¹ at a pressure of 20 bar.

14: The filtration membrane of claim 1, made by a process comprising:
dissolving the polysulfone and the polyvinylpyrrolidone in a solvent to form a solution;
fixing the thermoplastic substrate on a glass surface;
spreading the solution on the thermoplastic substrate fixed on the glass surface to form a support;
soaking the support in an organic anionic surfactant;
dipping the support in an aqueous solution of the tetramine to adsorb the tetramine to the support and form the first layer;
contacting the first layer with an organic solution of the phthaloyl chloride to form the polyamide; and
heating to form the filtration membrane.

15: The method of claim 14, wherein the heating is from 50 to 120° C.

16: The method of claim 15, wherein the heating occurs for 20 to 120 minutes.

17: A method of nanofiltration, comprising:
passing a composition through the filtration membrane of claim 1,
wherein the composition comprises at least solvents and solutes,
collecting a permeate passing through the filtration membrane to obtain a purified composition having a reduced amount of solutes.

18: The filtration membrane of claim 1, wherein the membrane has a rejection profile of solutes from 85 to 100% by weight.

19: The method of claim 17, further comprising:
contacting the filtration membrane with an aqueous acidic solution before passing a composition through the filtration membrane.

20: The method of claim 17, wherein passing a composition through the filtration membrane occurs for 0.5 to 15 hours.
